(19) United States
(12) Patent Application Publication
(10) Pub. No.: US 2011/0312102 A1
(43) Pub. Date: Dec. 22, 2011

(54) LIGHT TRANSMISSIVE TEMPERATURE CONTROL APPARATUS AND BIO-DIAGNOSIS APPARATUS INCLUDING THE SAME

(75) Inventor: Sung-ho JO, Changwon-city (KR)

(73) Assignee: SAMSUNG TECHWIN CO., LTD., Changwon-city (KR)

(21) Appl. No.: 13/162,081

(22) Filed: Jun. 16, 2011

(30) Foreign Application Priority Data
Jun. 16, 2010 (KR) 10-2010-0057117
Sep. 1, 2010 (KR) 10-2010-0085502
Apr. 13, 2011 (KR) 10-2011-0034419

(51) Int. Cl. G01N 21/00

(52) U.S. Cl. 436/164; 422/82.09

(57) ABSTRACT

A light transmissive temperature control apparatus, a bio-diagnosis apparatus including the transmissive temperature control apparatus, and a method of diagnosing biochemical reaction using the bio-diagnosing apparatus are provided. The light transmissive temperature control apparatus includes at least one tube which is formed of a light transmissive material and configured to contain a sample; and a temperature control unit which accommodates at least a part of the at least one tube which is transparent, guides light to be irradiated onto the at least one tube, and controls a temperature of the at least one tube.

### CROSS-REFERENCE TO RELATED PATENT APPLICATIONS

This application claims priority from Korean Patent Application Nos. 10-2010-0057117, 10-2010-0085502 and 10-2011-0034419, filed on Jun. 16, 2010, Sep. 1, 2010 and Apr. 13, 2011, respectively, in the Korean Intellectual Property Office, the disclosures of which are incorporated herein in their entirety by reference.

### BACKGROUND

1. Field

Apparatuses and methods consistent with exemplary embodiments relate to detecting biochemical reaction such as polymerase chain reaction (PCR) using a bio-diagnosis apparatus including a transmissive temperature control apparatus, and more particularly, to effectively controlling temperatures of tubes for nucleic acid amplification and detecting the nucleic acid amplification in real time using a bio-diagnosis apparatus including the light transmissive temperature control apparatus.

2. Description of the Related Art

Nucleic acid (DNA and RNA) amplification technologies have a wide range of applications for the purposes of research and development and diagnosis in fields of bio-science, genetic engineering, medical science, and the like. Among these nucleic acid amplification technologies, a nucleic acid amplification technology using polymerase chain reaction (PCR) has widely been utilized. PCR is used when a specific nucleic acid sequence of a genome needs to be amplified as needed.

PCR is performed by a series of temperature enzyme reaction processes like denaturation, annealing, extension, etc., and can acquire good quality and high yield of nucleic acid within a predetermined temperature range during each process.

A bio-diagnosis apparatus for monitoring a product amplified through PCR in real time detects fluorescent emission light generated by irradiating excitation light onto a sample during a sample amplification reaction.

In general, the excitation light is brighter than the emission light. The excitation light and the emission light are introduced into an emissive light detection apparatus, which makes it difficult to detect normal emission light if noise included in a signal increases. Generally, to reduce this noise, attempts to prevent the excitation light from being incident into the emissive light detection apparatus have been made, by installing various types of optical filters and lens units or adjusting an angle at an incident path of a light source. However, in this case, a structure of an optical system becomes complicated or a light path increases excessively, resulting in increase of the size of a PCR apparatus.

### SUMMARY

One or more exemplary embodiments provide a bio-diagnosis apparatus having a simple construction and capable of minimizing a light path for biochemical reaction such as nucleic acid amplification.

One or more exemplary embodiments also provide a bio-diagnosis apparatus capable of implementing precise detection performance by minimizing noise due to excitation light.

One or more exemplary embodiments also provide a light transmissive temperature control apparatus for quickly and effectively controlling temperatures of tubes for biochemical reaction and a bio-diagnosis apparatus including the transmissive temperature control apparatus.

According to an aspect of an exemplary embodiment, there is provided a light transmissive temperature control apparatus including: at least one tube which is formed of a light transmissive material and configured to contain a sample; and a temperature control unit which accommodates at least a part of the at least one tube which is transparent, guides light to be irradiated onto the at least one tube, and controls a temperature of the at least one tube.

The temperature control unit may include a thermoelectric device block including at least one hole in which the at least a part of the at least one tube is inserted.

The temperature control unit may include an electrode formed of a transparent material and generating heat if current is applied to the electrode.

The light transmissive temperature control apparatus may further include a heat sink formed of a thermal transfer material to transfer out heat generated from the at least one tube.

The temperature control unit may include: a thermoelectric device block comprising at least one hole in which at least a part of the at least one tube is inserted, and controls the temperature of the at least one tube; and a heating block including a transparent layer formed of a transparent material and disposed on one surface of the thermoelectric device block to support a bottom end of the at least one tube, and an electrode formed on the transparent layer and generating heat if current is applied to the electrode.

The temperature control unit may include: a transparent layer formed of a transparent material and at least one accommodation groove into which the at least one tube is inserted; and an electrode formed on the transparent layer and generating heat.

The heat sink may include a heat pipe, surrounding the at least one tube, through which a cooling material flows.

According to an aspect of another exemplary embodiment, there is provided a bio-diagnosis apparatus including: the above light transmissive temperature control apparatus; a light generation unit disposed on one side of the light transmissive temperature control apparatus and irradiating the light onto the at least one tube; and a light detection unit disposed on another side of the light transmissive temperature control apparatus and detecting emission light generated from the at least one tube.

The light detection unit nay comprise a plurality of field lenses. The light generation unit may comprise: a light source which generates the light; and at least one optical fiber which transmits the light output from the light source into the at least one tube, respectively.

The at least one optical fiber may include: a plurality of optical fiber bundles through which the light is transmitted into the at least one tube, respectively. The light generation unit may further include a homogenizing lens which homogenizes the light output from the light source and transfers the light to each of the at least one optical fiber.

The plurality of optical fiber bundles may have a same length.

The homogenizing lens may be a rod lens or a fly-eye lens.

The light source may include: a plurality of one-color light emitting diodes (LEDs); and a plurality of dichroic filters corresponding to the plurality of one-color LEDs.

The bio-diagnosis apparatus may further include: condenser lenses disposed between the plurality of one-color LEDs; and a focusing lens disposed between the plurality of dichroic filters and the homogenizing lens.

The temperature control unit may include a thermoelectric device block which includes at least one hole in which the at least a part of the at least one tube is inserted, and controls the temperature of the at least one tube.

The at least one hole may be formed from one surface of the thermoelectric device block and connected to another at least one hole formed from another surface thereof, respectively, and may be transparent between the at least one hole and the other at least one hole, respectively.

At least one optical fiber may be inserted into the other at least one hole, respectively, from the other surface of the thermoelectric device block, and at least one lid which blocks the other at least one hole, respectively, may be installed in the other surface of the thermoelectric device block.

According to an aspect of another exemplary embodiment, there is provided a diagnosis apparatus including: a light generation unit which outputs the light from a light source; the above light transmissive temperature control apparatus including a thermoelectric device block which comprises at least one support hole, in which the at least a part of the at least one tube is inserted, respectively; and at least one a light transmissive hole, connected to the at least one support hole, respectively, through which the light is transmitted to the at least one tube; and a light detection unit detecting emission light generated from the at least one tube by the light transmitted through the at least one light transmissive hole, wherein the at least one support hole and the at least one light transmissive hole are connected to each other, respectively, at an angle equal to or less than 90°.

The at least one support hole and the at least one light transmissive hole are connected to each other, respectively, at an angle equal to or less than 90° so that a light path of the light output from the light source and a light path of the emission light forms the angle equal to or less than 90°

The light generation unit comprises a plurality of light sources that are spaced apart from one another and output the light.

The bio-diagnosis apparatus may further include: a first cooling module in which two or more of the plurality of light sources are mounted, and which cools the mounted two or more light sources.

The light generation unit may include: a first light source which outputs excitation light of a first wavelength band into a first light transmissive hole among the at least one light transmissive hole; and a second light source which outputs excitation light of a second wavelength band into a second light transmissive hole among the at least one light transmissive hole.

The excitation lights output from the first and second light sources may be transmitted into the first and second light transmissive holes to be incident on corresponding tubes among the at least one tube, respectively and simultaneously.

A straight medium which increases straightness of the light or optical fiber may be filled in an entrance part of the at least one light transmisisve hole or at least a part thereof.

The thermoelectric device block may be configured to rotate about a rotational axis. The at least one light transmissive hole may include a plurality of light transmissive holes and may be disposed in the thermoelectric device block to form a circle with respect to the rotational axis, and when the thermoelectric device block rotates in such a way that each of the plurality of light transmissive holes are sequentially disposed at a position corresponding to the light.

The light generation unit may include a plurality of light sources generating respective excitation lights having different wavelengths, and a combination of the respective excitation lights may be incident on the at least one tube through the at least one light transmissive hole.

The at least one support hole may be formed to penetrate from a top surface of the thermoelectric device block to a bottom surface thereof, and to receive the light incident through the bottom surface, and the at least one light transmissive hole may be configured to output emission light generated from the at least one tube.

According to an aspect of another exemplary embodiment, there is provided a method of diagnosing biochemical reaction using a bio-diagnosing apparatus comprising a thermoelectric device block. The method may include: inserting at least one transparent container containing a sample into at least one support hole formed in the thermoelectric device block; controlling a temperature of the at least one container through the thermoelectric device block so that the sample undergoes the biochemical reaction; irradiating excitation light on the at least one container through at least one light transmissive hole connected to the at least one support hole, respectively; and detecting emission light generated from the at least one container through a light path which is different from a light path of the excitation light.

The light path through with the emission light is generated and the light path of the excitation light form an angle equal to or less than 90°.

The excitation light may be irradiated on the at least one container during the biochemical reaction.

### BRIEF DESCRIPTION OF THE DRAWINGS

The above and other aspects will become more apparent by describing in detail exemplary embodiments thereof with reference to the attached drawings, in which:

FIG. 1 is a schematic side cross-sectional view of a bio-diagnosis apparatus, according to an exemplary embodiment;

FIG. 2 is a schematic side cross-sectional view of a light transmissive temperature control apparatus included in the bio-diagnosis apparatus of FIG. 1, according to an exemplary embodiment;

FIG. 3 is a schematic side cross-sectional view of a light transmissive temperature control apparatus, according to another exemplary embodiment;

FIG. 4 is a schematic side cross-sectional view of a light transmissive temperature control apparatus, according to another exemplary embodiment;

FIG. 5 is a schematic side cross-sectional view a light transmissive temperature control apparatus, according to another exemplary embodiment;

FIG. 6 is a schematic view of a bio-diagnosis apparatus according to an exemplary embodiment;

FIG. 7 is a schematic view of light emitting diodes (LEDs) of plural one-color light used as a light source in a bio-diagnosis apparatus, according to an exemplary embodiment;

FIG. 8 is a schematic view of a thermal cycling unit of a bio-diagnosis apparatus, according to an exemplary embodiment;

FIG. 9 is an exploded perspective view of a bio-diagnosis apparatus that is cooled by using an additionally installed circulating fluid cooling system, according to an exemplary embodiment;

FIG. 10 is a schematic view of a heat pipe installed in a cooling block of a bio-diagnosis apparatus of FIG. 9, according to an exemplary embodiment;

FIG. 11 is a schematic view of a bio-diagnosis apparatus, according to an exemplary embodiment;

FIG. 12 is a cross-sectional view taken along a line II-II of the bio-diagnosis apparatus of FIG. 11, according to an exemplary embodiment;

FIG. 13 is a schematic view of a bio-diagnosis apparatus according to another exemplary embodiment;

FIG. 14 is a schematic view of a bio-diagnosis apparatus according to another exemplary embodiment;

FIG. 15 is a schematic view of a bio-diagnosis apparatus according to another exemplary embodiment;

FIG. 16 is a cross-sectional view of a thermoelectric device block of a bio-diagnosis apparatus, according to an exemplary embodiment;

FIG. 17 is a schematic view of a bio-diagnosis apparatus according to another exemplary embodiment;

FIG. 18 is a cross-sectional view of a rotating thermoelectric device block of the bio-diagnosis apparatus of FIG. 17, according to an exemplary embodiment; and

FIG. 19 is graph showing spectrums of each LED light source and transmittance of filters corresponding to the each LED light source, according to an exemplary embodiment.

### DETAILED DESCRIPTION OF EXEMPLARY EMBODIMENTS

Exemplary embodiments will now be described more fully with reference to the accompanying drawings.

In the following exemplary embodiments, a bio-diagnosis apparatus relating may be referred to as a real-time detective polymerase chain reaction (PCR) apparatus, a nucleic acid inspection apparatus, or etc.

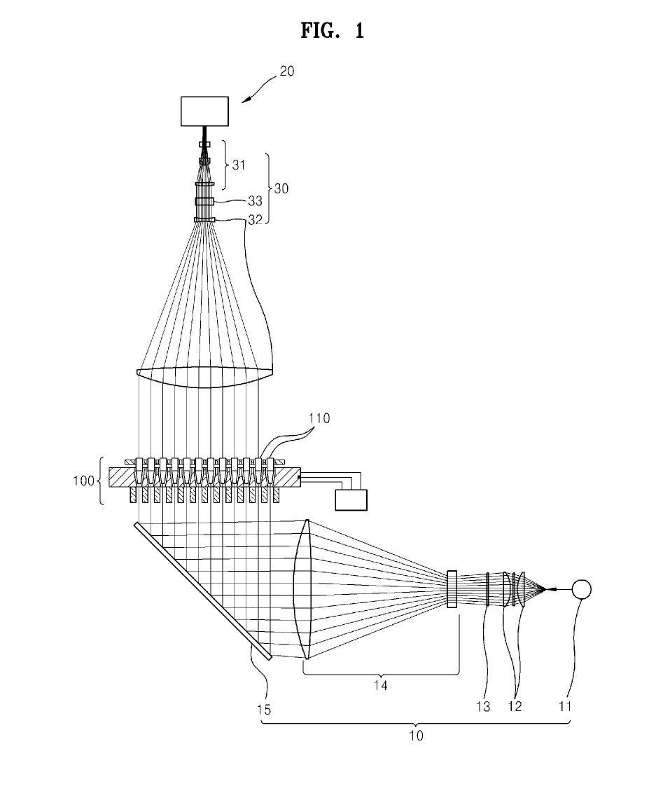

FIG. 1 is a schematic view a bio-diagnosis apparatus according to an exemplary embodiment.

Referring to FIG. 1, the bio-diagnosis apparatus includes a light transmissive temperature control apparatus 100 for controlling temperatures of tubes 110 that contain samples and transmitting light, a light generation unit 10 that irradiates light toward the tubes 110, and a light detection unit 20 that detects emissive light generated from the tubes 110.

A related art technology for determining a degree of amplification of a nucleic acid sample uses electrophoresis after completing all amplification processes. Such technology, however, may not determine the degree of amplification of the nucleic acid sample during the amplification processes.

The bio-diagnosis apparatus according to the present exemplary embodiment may enable monitoring the degree of nucleic acid amplification in real time by controlling temperature conditions of the tubes 110 and detecting fluorescent emission light generated by irradiating light onto the tubes 110 in order to amplify the nucleic acid sample to be amplified, simultaneously.

The light generation unit 10 is disposed at one side of the light transmissive temperature control apparatus 100 and irradiates light toward the tubes 110 that contain nucleic acid samples. The light generation unit 10 includes a light source 11 for generating light, homogenizing lenses 12 for homogenizing a Gaussian beam of the light source 11, a first excitation filter 13 for transmitting light having a wavelength of a specific range, magnification lenses 14 for magnifying the filtered light, and a refraction unit 15 for refracting a direction of the light to the light transmissive temperature control apparatus 100.

For the light source 11, a plurality of light emitting diodes (LEDs), an arrangement of the LEDs, a laser, a halogen lamp, or a different type of an appropriate light generation apparatus may be used as the light source 11.

The light irradiated onto the light transmissive temperature control apparatus 100 from the light source 11 undergoes a homogenizing process through the homogenizing lenses 12. Thereafter, the light is magnified by the magnification lenses 14 through the first excitation filter 13 and is uniformly irradiated onto the tube 110 of the light transmissive temperature control apparatus 100. The tubes 110 are formed of transmissive materials, and thus, the light is incident onto the nucleic acid samples contained in the tubes 110 through the tubes 110. If the light is irradiated onto the tube 110, emission light is generated from emission covers included in the nucleic acid samples.

The emission light generated in the tube 110 forms an image on the light detection unit 20 by using an imaging optical system 30. The image forming optical system 30 includes lenses 31 and 32 for collimating the emission light generated from the light transmissive temperature control apparatus 100, and a second excitation filter 33 for transmitting light having a wavelength of a specific range from the emission light. The second excitation filter 33 blocks excitation light including the light irradiated onto the tube 110 and transmits the emission light, thereby minimizing an affect of noise.

The imaging optical system 30 may use a microscope objective lens instead of a telecentric lens, thereby implementing a fluorescent microscopy capable of observing the nucleic acid amplification processes in a molecular level.

The light detection unit 20 may be implemented by using a sensor such as a photo diode, a charge-coupled device (CCD), a complementary metal-oxide-semiconductor (CMOS) device, etc. The light detection unit 20 receives the emission light generated from the light transmissive temperature control apparatus 100 and generates an electrical signal corresponding to the received emission light. Thus, the degree of nucleic acid amplification can be quantitatively determined in real time from the electrical signal of the light detection unit 20.

Polarizers may be disposed on a light path from the light generation unit 10 to the light detection unit 20 to reduce the affect of noise.

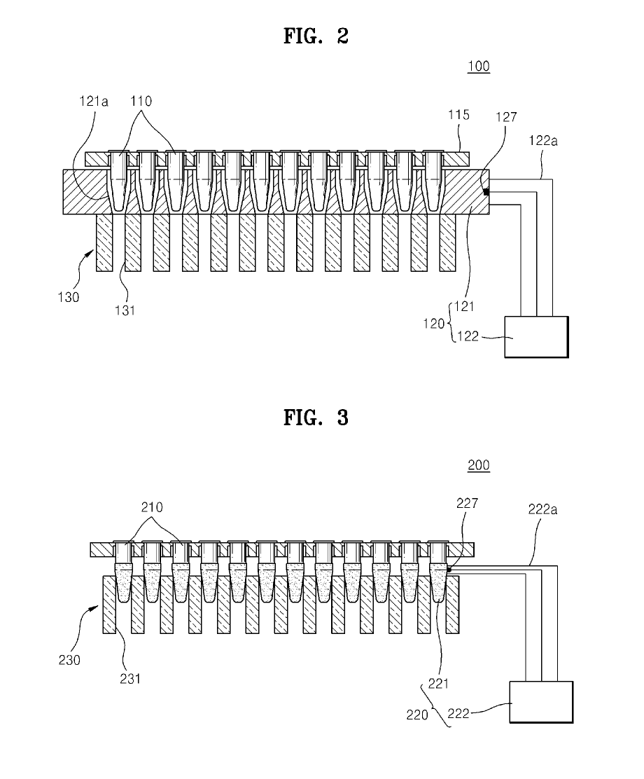

FIG. 2 is a schematic side cross-sectional view of the light transmissive temperature control apparatus 100 included in the bio-diagnosis apparatus of FIG. 1 according to an exemplary embodiment.

Referring to FIG. 2, the light transmissive temperature control apparatus 100 includes the tubes 110 which are formed of transmissive materials and can contain samples therein, and a temperature control unit 120 which controls temperatures of the tubes 110.

The light transmissive temperature control apparatus 100 is implemented as a thermal cycler, and heats or cools the temperatures of the tube 110 in accordance with periods required by the temperature control unit 120 for nucleic acid amplification. The light transmissive temperature control apparatus 100 of the present exemplary embodiment is not limited to the thermal cycler. According to an exemplary embodiment, the light transmissive temperature control apparatus 100 may be manufactured to operate as an isothermal block and may be used to implement isothermal target and probe amplification.

The tubes 110 are formed of transparent plastic materials or glass materials, and thus, light can be transmitted through the tube 110. Nucleic acid samples to be amplified may be contained in the tubes 110. Top ends of the tubes 110 are supported by a support plate 115. The tubes 110 are inserted into a thermoelectric device block 121 of the temperature control unit 120.

The temperature control unit 120 includes the thermoelectric device block 121 that is disposed outside or around the tubes 110 to control the temperatures of the tubes 110, and a controller 122 that controls the thermoelectric device block 121. The thermoelectric device block 121 may be implemented as, for example, a Peltier device.

The Peltier device is a thermoelectric conversion device using the Peltier effect that uses a thermoelectric phenomenon in which heat is generated or absorbed in a bonding portion of two types of metals when current is applied to the two types of metals. Therefore, the controller 122 applies current to the thermoelectric device block 121 through an electric wire 122a, which increases or reduces a temperature of the thermoelectric device block 121, thereby controlling the temperatures of the tubes 110.

The controller 122 may be implemented as, for example, a semiconductor chip or a circuit board using the semiconductor chip.

A temperature sensor 127 may be installed in the thermoelectric device block 121. The controller 122 may control the temperature of the thermoelectric device block 121 based on a detection signal of the temperature sensor 127.

The controller 122 also performs a function of transmitting light through the tubes 110. To this end, the thermoelectric device block 121 includes a plurality of thorough holes 121a into which the tubes 110 are inserted. The thorough holes 121a of the thermoelectric device block 121, contact side surfaces of the tubes 110, support the tubes 110, and function as light paths by which incident light enters into the tubes 110.

The light transmissive temperature control apparatus 100 may further include a heat sink 130 formed of a heat transfer material. The heat sink 130 contacts one surface of the thermoelectric device block 121 and includes a plurality of thorough holes 131 corresponding to each of the tubes 110. The heat sink 130 may transfer heat generated in the thermoelectric device block 121 and supplement quick cooling. The heat sink 130 may be formed of a thermoelectric metal such as aluminum or copper. The heat sink 130 can achieve a cooling effect using a natural convection effect. The heat sink 130 may be formed in a structure of a heat pipe in addition to a structure as shown.

In addition to the structure in which the heat sink 130 is installed, various technologies may be introduced to supplement the cooling effect. For example, although not shown, an air supplying unit for supplying air or a cooling pipe through which cooling fluid flows may be installed.

The light transmissive temperature control apparatus 100 having the structure described above and the bio-diagnosis apparatus including the light transmissive temperature control apparatus 100 may effectively amplify and detect, for example, DNA.

A PCR apparatus which shows only a normal result of DNA amplified by using gel electrophoresis at an end-point has many problems such as accuracy of a quantitative detection of DNA. To address these problems, a bio-diagnosis apparatus which quantitatively analyzes DNA by detecting intensity of emission light in proportion to density of amplified DNA by using an optical detection system may be used. However, if both excitation light and emission light enter the bio-diagnosis apparatus, much noise is included in an output signal. To address this problem, a construction of an optical system becomes complicated, and a light path increases excessively, which results in increase of the size of the bio-diagnosis apparatus.

To amplify DNA, a sample, which includes template DNA to be amplified, an oligonucleotide primer pair having a sequence complimentary to a specific sequence of each single-stranded template DNA, thermostable DNA polymerase, and deoxyribonucleotide triphosphates (dNTP), is prepared.

A base sequence of a specific part of the template DNA is amplified by repeating a temperature cycle for sequentially changing the temperatures of the tubes 110 after placing the prepared sample in the tubes 110 of the light transmissive temperature control apparatus 100. More specifically, a 3-step or 2-step temperature circulation cycle is used.

In a first step that is a denaturation step, the sample is heated at a high temperature, and thus, double-stranded DNA is separated into single-stranded DNA.

In a second step that is an annealing step, the sample that undergoes the denaturation step is cooled at an appropriate temperature, and thus, a partially double-stranded DNA-primer complex is formed by double screw coupling the single-stranded DNA and the primer.

In a third step that is a polymerization step, the sample that undergoes the annealing step is maintained at an appropriate temperature, and the primer of the DNA-primer complex extends according to a polymerization reaction of DNA polymerase, and thus, new single-stranded DNA having a complementary sequence is replicated with respect to the original template DNA.

These three steps are sequentially repeated between 20 to 40 times, and DNA between two primers is replicated for each cycle, and thus, DNA amplification of several millions or more times can be achieved.

The temperature of the denaturation step is between 90° C. and 95° C. The temperature of the annealing step is appropriately adjusted according to a melting point (Tm) of the primer, and is between 40° C. and 60° C. The temperature of the polymerization step is 72° C. that is an optimal activation temperature of high stability tag DNA polymerase extracted from mainly used Thermus aquaticus, and thus, the 3-step temperature circulation cycle may be generally used. Since the tag DNA polymerase has a very wide activation temperature range, the 2-step temperature circulation cycle by equalizing the temperatures of the annealing step and the polymerization step may also be used.

If the temperature of the annealing step is reduced since a predetermined temperature is not maintained, and a temperature for each step is not quickly changed, a yield is greatly influenced since the primer is not attached at an appropriate position to be amplified.

The light transmissive temperature control apparatus 100 of FIGS. 1 and 2 uses the thermoelectric device block 121 including the thorough holes 121a that guides externally incident light toward the tubes 110, thereby effectively heating and cooling the tubes 110 and effectively detecting emission light.

FIG. 3 is a schematic side cross-sectional view of a light transmissive temperature control apparatus 200 according to another exemplary embodiment.

Referring to FIG. 3, the light transmissive temperature control apparatus 200 includes a plurality of tubes 210 that are formed of transmissive materials and contain samples therein, and a temperature control unit 220 that controls temperatures of the tubes 210.

The temperature control unit 220 includes electrodes 221 that are disposed on surfaces of the tubes 210, respectively, and control the temperatures of the tubes 210, and a controller 222 that controls application of current to the electrodes 221. The electrodes 221 may be manufactured by coating a transparent material, such as a carbon nanotube (CNT) film or an indium tin oxide (ITO) film, on the surfaces of the tubes 210. The electrodes 221 are electrically connected to the controller 222 via an electric wire 222a.

A temperature sensor 227 may be installed outside the controllers 210. The controller 222 may control the temperatures of the tubes 210 based on a detection signal of the temperature sensor 227.

The light transmissive temperature control apparatus 200 may include a heat sink 230 formed of a heat transfer material which includes a plurality of thorough holes 231 into which the electrodes 221 are inserted. The heat sink 230 may transfer heat generated in the electrodes 221 of the surfaces of the tubes 210 to the outside and supplement quick cooling. The heat sink 230 may be formed of a thermoelectric metal such as aluminum or copper.

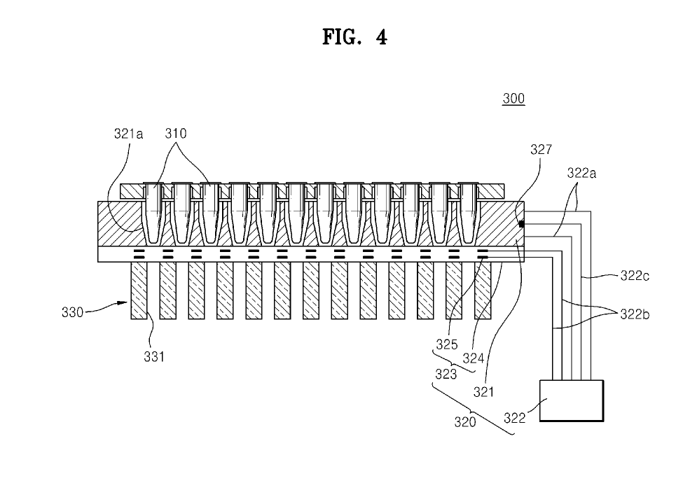

FIG. 4 is a schematic side cross-sectional view a light transmissive temperature control apparatus 300 according to another exemplary embodiment.

Referring to FIG. 4, the light transmissive temperature control apparatus 300 includes a plurality of tubes 310 that are formed of transmissive materials and contain samples therein, and a temperature control unit 320 that controls temperatures of the tubes 310.

The temperature control unit 320 includes a thermoelectric device block 321 that is disposed on or around surfaces of the tubes 310 and controls the temperatures of the tubes 310, a heating block 323 that is formed of a transparent material and supports bottom end portions of the tubes 310, and a controller 322 that controls the thermoelectric device block 321 and the heating block 323.

The thermoelectric device block 321 may be implemented as, for example, a Peltier device. The thermoelectric device block 321 may be electrically connected to a controller 322 through a first wire 322a, and heat or cool the tubes 310 according to application of current from the controller 322. The thermoelectric device block 321 includes a plurality of thorough holes 321a into which the tubes 310 are inserted.

The heating block 323 includes a transparent layer 324 that is formed of, for example, a glass or transparent plastic material, and an electrode 325 that is formed on the transparent layer 324 and generates heat if current is applied thereto. The electrode 325 is connected to a controller 322 via a second wire 322b.

The electrodes 325 may be deposited on a surface of the transparent layer 324 by using a transparent material, such as a CNT film or an ITO film, or may be buried in the transparent layer 324 as shown in FIG. 4. The electrodes 325 may be disposed outside the transparent layer 324 at positions corresponding to the tubes 310. Although the electrodes 325 are manufactured to transmit light, the electrodes 325 are disposed to avoid a path of light incident into the tubes 310, thereby increasing transmittance of light incident into the tubes 310. When the electrode 325s are disposed to avoid the path of light, the electrodes 325 may not necessarily be formed of a transparent material, and may be formed of various materials having electric conductivity such as copper or nickel.

The light transmissive temperature control apparatus 300 may include a temperature sensor 327 that is disposed on the thermoelectric device block 321 or the heating block 323 and detects a temperature thereof. The controller 322 is connected to the temperature sensor 327 via a third wire 322c, thereby controlling the temperatures of the tubes 310 based on a detection signal of the temperature sensor 327.

The light transmissive temperature control apparatus 300 may include a heat sink 330 formed of a heat transfer material. The heat sink 330 includes a plurality of thorough holes 331 corresponding to each of the tubes 310. The heat sink 330 may transfer heat generated in the heating block 323 to the outside and supplement quick cooling. The heat sink 330 may be formed of a thermoelectric metal such as aluminum or copper.

The light transmissive temperature control apparatus 300 having the structure stated above may effectively control the temperatures of the tubes 310 using functions of the thermoelectric device block 321 and the heating block 323, and may effectively detect a degree of nucleic acid amplification since light is incident into the tubes 310 through the thorough holes 331 of the heat sink 330, the transparent layer 324 and the thorough holes 321a of the thermoelectric device block 321 and generate emission light.

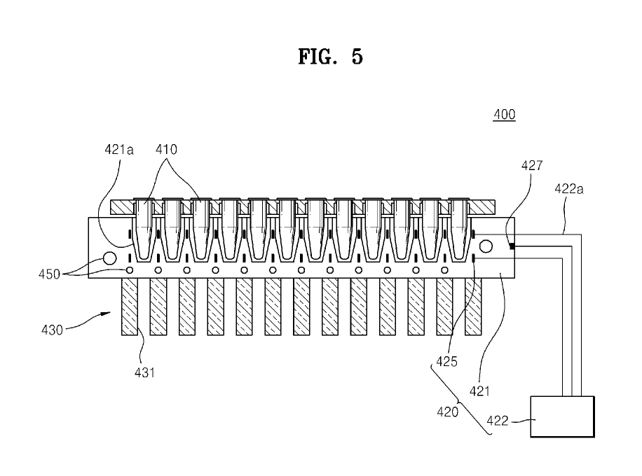

FIG. 5 is a schematic side cross-sectional view of a light transmissive temperature control apparatus 400 according to another exemplary embodiment.

Referring to FIG. 5, the light transmissive temperature control apparatus 400 includes a plurality of tubes 410 that are formed of transmissive materials and contain samples therein, and a temperature control unit 420 that controls temperatures of the tubes 410.

The temperature control unit 420 includes a transparent layer 421 formed of a transparent material including a plurality of accommodation grooves 421a into which the tubes 410 are inserted, electrodes 425 that are installed in the transparent layer 421 and generate heat, and a controller 422.

The transparent layer 421 is formed of, for example, a glass material or a transparent plastic material, and may transmit light. The electrodes 425 are connected to the controller 422 through an electric wire 422a. The electrodes 425 may generate heat when the controller 422 applies current to the electrode 425. The electrodes 425 may be deposited on a surface of the transparent layer 421 by using a transparent material, such as a CNT film or an ITO film, or may be buried in the transparent layer 421 as shown in FIG. 5.

The electrode 425 may be disposed outside the transparent layer 421 at a position corresponding to the tubes 410, respectively. The electrodes 425 are disposed to avoid a path of light incident into the tubes 410, thereby increasing transmittance of light incident into the tubes 410, and preventing a light interference phenomenon that occurs between the tubes 410. For example, if the electrodes 425 are respectively disposed to surround the tubes 410, performance of heating the tube 410 may be greatly increased.

When the electrodes 425 are disposed to avoid the path of light, the electrodes 425 may not necessarily be formed of transparent materials, and may be formed of various materials having electric conductivity such as copper or nickel.

The light transmissive temperature control apparatus 400 may include a temperature sensor 427 that is disposed on the transparent layer 421 and detects a temperature thereof. The controller 422 may control temperatures of the tube 410 based on a detection signal of the temperature sensor 427.

The light transmissive temperature control apparatus 400 may further include a heat sink 430 formed of a heat transfer material. the heat sink 430 contacts one surface of the transparent layer 421. The heat sink 430 may transfer heat generated in the transparent layer 421 to the outside and supplement quick cooling. The heat sink 430 may be formed of a thermoelectric metal such as aluminum or copper. The heat sink 430 mat achieve a cooling effect owing to a natural convection effect.

A plurality of cooling pipes 450 through which a cooling fluid flows may be buried in the transparent layer 421. The cooling pipes 450 may be disposed to avoid positions of the tubes 410 in order not to prevent light from being incident into the tubes 410.

The tubes 410 may be quickly cooled according to dissipation due to the convection effect that uses the heat sink 430 and a function of the cooling fluid flowing through the cooling pipes 450.

A bio-diagnosis apparatus according to an embodiment of the present will now be described with reference to the accompanying drawings.

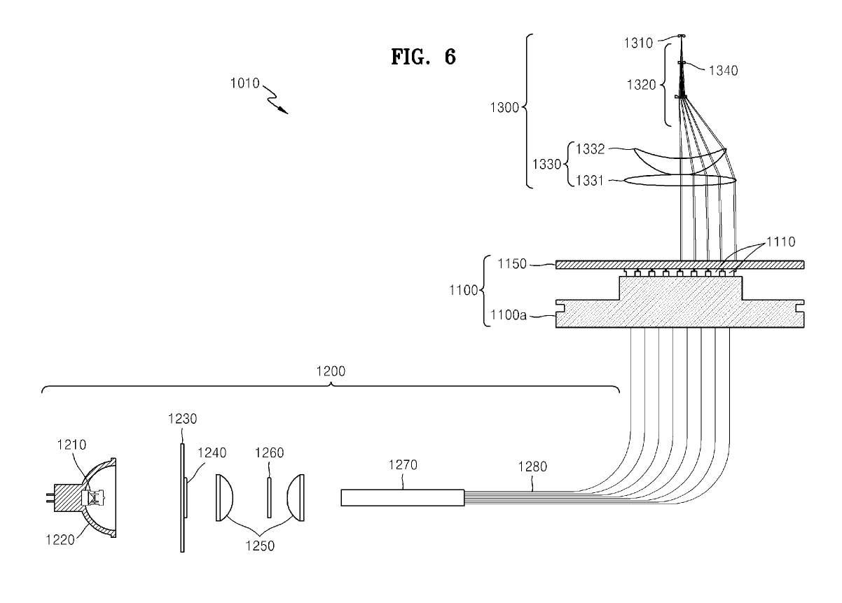

FIG. 6 is a schematic view of a bio-diagnosis apparatus 1010 according to another exemplary embodiment.

Referring to FIG. 6, the bio-diagnosis apparatus 1010 may include a thermal cycling unit 1100, corresponding to the light transmissive temperature control apparatus 100 of FIG. 1, a light generation unit 1200, and a light detection unit 1300.

The thermal cycling unit 1100 may contact at least a part of a tube 1110, and include a thorough hole used to transfer light energy. Light may transmit the tube 1110 which contains a sample. The thermal cycling unit 1100 may accommodate at least one tube 1110, for example, a plurality of tubes 1110.

The light generation unit 1200 may irradiate light output from a light source 1210 onto the tube 1110 in which the sample is contained from one side of the thermal cycling unit 1100 through light fiber 1280. The light detection unit 1300 may detect emission light generated in the sample from another side of the thermal cycling unit 1100 according to the light irradiated from the one side of the thermal cycling unit 1100.

The thermal cycling unit 1100 may be implemented as a light transmissive thermal cycler. That is, excitation light may be irradiated onto the sample from the one side of the thermal cycling unit 1100, and accordingly emission light is generated and may be detected from the other side opposite to the one side of the thermal cycling unit 1100.

Therefore, the bio-diagnosis apparatus 1010 may vary methods of implementing an optical system and increase light efficiency by applying the light transmissive thermal cycler.

The thermal cycling unit 1100 may support at least a part of the at least one tube 1110 where the sample is contained. To this end, the thermal cycling unit 1100 may include a thermoelectric device block 1100a, corresponding to the thermoelectric device block 121 of FIG. 2, that contacts at least a part of the at least one tube 1110 through which light is transmitted.

The thermoelectric device block 1100a that supports the at least one tube 1110 may include thorough holes used to transfer light or light energy. Light may be irradiated onto the at least one tube 1110 from above or below the at least one tube 1110, and emission light may be detected from another side of the at least one tube 1110.

Nucleic acid such as DNA and/or RNA of the sample may be amplified by using a nucleic acid amplification technology using PCR among various nucleic acid amplification technologies. PCR is used when a specific base sequence included in a genome is amplified as needed.

PCR is performed through a series of temperature enzyme reaction processes like denaturation, annealing, extension, etc., and may acquire good quality and high yield of nucleic acid within a predetermined temperature range during each process.

The thermal cycling unit 1100 may establish a temperature condition necessary for nucleic acid amplification of the sample in order to induce the nucleic acid amplification of the sample contained in the at least one, for example, the plurality of tubes 1110. To this end, the thermal cycling unit 1100 may use a thermoelectric device, such as a Peltier device.

Meanwhile, the bio-diagnosis apparatus 1010 may irradiate excitation light onto the sample during an amplification reaction of the sample, and accordingly emission light is generated and may be detected in real time.

The excitation light may be irradiated onto the sample that generates the nucleic acid amplification reaction from one side of the thermoelectric device block 1100a. Also, if the excitation light is irradiated onto the sample that generates the nucleic acid amplification reaction, emission light may be generated. The emission light may be detected from another side of the thermoelectric device block 1100a, i.e. a side opposite to the side of the thermoelectric device block 1100a onto which the excitation light is irradiated.

A thermal cycler for establishing the temperature condition necessary for the nucleic acid amplification is required to amplify nucleic acid according to PCR.

A nucleic acid optical system using a related art Peltier device may irradiate light from a light source from a top surface of a thermoelectric device block and detect emission light from the top surface of the thermoelectric device block. Thus, the nucleic acid optical system must have a limited construction.

The more the number of emission light dyes used in an optical system using a beam splitter, the more the number of parts of the light source and an illumination optical system, which may cause cumbersome and high cost problems.

When an oblique illumination method is used, the entire optical system may be greatly increased in size. Thus, a complicated reflection mechanism has to be selected in order to reduce the volume of the entire optical system.

Furthermore, a related art optical system, corresponding to the light generation unit 1200 of FIG. 6, for large area illumination uses a large caliber lens of a telecentric camera as an illumination lens for scattering light. When such coaxial illumination is used to illuminate a large area, non-uniformity of light intensity occurs in which a center of the large area is high and a boundary thereof becomes lower.

Since an area of an individual well, corresponding to the tube 1110 of FIG. 6, that occupies an entire well plate is less than half the well plate, an amount of light incident into a well is reduced below half, which deteriorates light efficiency. That is, the coaxial illumination results in low light efficiency, and needs normalizing of light intensity in a software manner due to the non-uniformity of light intensity.

However, the bio-diagnosis apparatus 1010 of the present exemplary embodiment employs the thermal cycling unit 1100 as a light transmissive thermal cycler, thereby varying methods of implementing the optical system and increasing light efficiency.

The light generation unit 1200 may irradiate light, as excitation light, output from the light source 1210 onto the at least one tube 1110 where the sample is contained from one side of the thermoelectric device block 1100a through the light fiber 1280.

The light generation unit 1200 may include the light source 1210, at least one optical fiber bundle 1280, and a homogenizing lens 1270.

The light source 1210 generates light. The optical fiber bundle 1280 directly and individually allows the light output from the light source 1210 incident into the at least one tube 1110. The homogenizing lens 1270 homogenizes the light output from the light source 1210 and transfers the light to each of the at least one optical fiber bundle 1280.

If the thermal cycling unit 1100 includes a plurality of tubes 1110, the light generation unit 1200 may include a plurality of optical fiber bundles 1280 respectively corresponding to the tubes 1110. Thus, the optical fiber bundles 1280 respectively allow the light incident into the tubes 1110. Therefore, efficiency of the light that is output from the light source 1210 and reaches the tubes 1110 where samples are contained may be maximized.

The bio-diagnosis apparatus 1010 may allow for uniform irradiation of excitation light onto each of the tubes 1110 where the samples are contained by using the optical fiber. Each of the optical fiber bundles 1280 may directly allow the light to be incident into the respective tubes 1110. Thus, the optical fiber bundles 1280 cause little light loss, thereby increasing light efficiency.

The optical fiber bundles 1280 can be flexible, which enables the formation of various structures from the light source 1210 to the thermal cycling unit 1100a, and an optical system in a small space, thereby increasing space utilization of the optical system compared to other methods.

The optical fiber bundles 1280 may extend from the homogenizing lens 1270 to the thermal cycling unit 1100a. The lengths of the optical fiber bundles 1280 extending from the homogenizing lens 1270 to the thermal cycling unit 1100a may be the same. Accordingly, uniform illumination of light may be transferred to each of the tubes 1110.

Therefore, emission light may be generated from the sample contained in each of the tubes 1110 under the same condition.

The homogenizing lens 1270 may be used to transfer light of uniform illumination to each of the optical fiber bundles 1280. The homogenizing lens 1270 may be a rod lens or a fly-eye lens.

Although the homogenizing lens 1270 is used as the rod lens in the present exemplary embodiment, the inventive concept is not limited thereto, and various types of lenses for homogenizing light may be used to irradiate uniform light from all regions of an output end.

The light generated from the light source 1210 may be emitted in a previously set direction through a reflector 1220, passes through a hole formed in a shutter 1230, and is diffused through a diffuser 1240. The light diffused through the diffuse 1240 is converted into parallel light through a condenser lens 1250, and is incident into the homogenizing lens 1270.

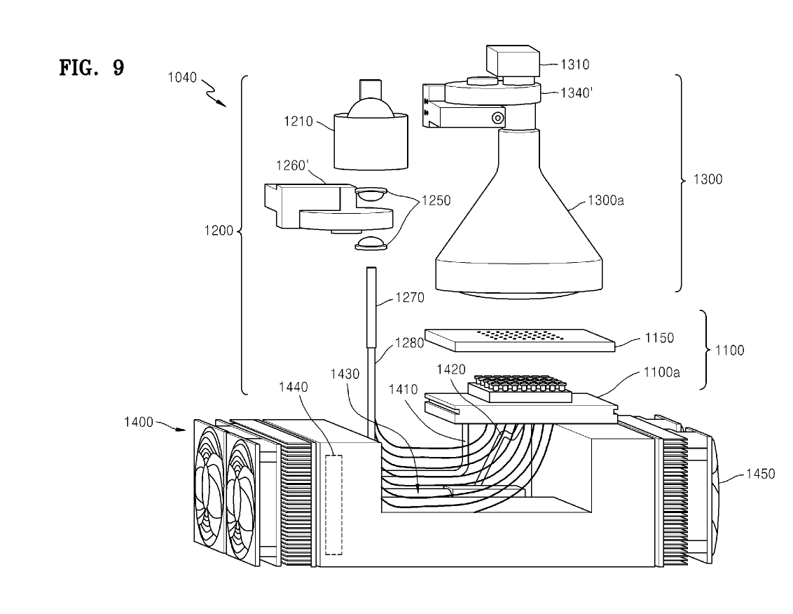

The light is transferred to the homogenizing lens 1270 by selecting a wavelength of a specific region through a first wavelength selection filter 1260. The first wavelength selection filter 1260 is implemented as a rotating filter wheel as shown in FIG. 9, which enables a selective application of a filter for selectively transmitting light of a desired specific wavelength band from among a plurality of filters.

As described above, the method of making light incident into respective tubes by using optical fiber bundles can maximize freedom of space arrangement and efficiency of illumination light in an illumination optical system due to the characteristic flexibility of optical fiber. Here, each tube needs be illuminated by the same number of the optical fiber bundles 1280 in order to remove a variation of light intensity between the tubes. The light may be incident into the optical fiber bundles 1280 after the homogenizing lens 1270 performs a light homogenizing operation of removing the variation of light intensity.

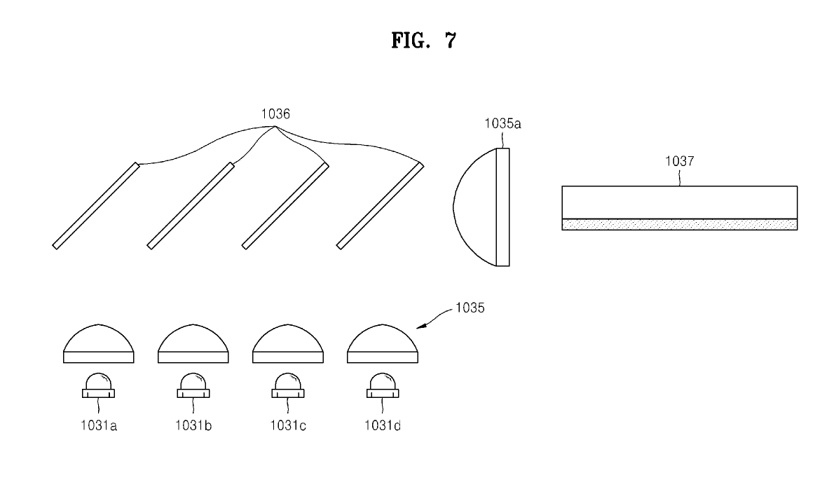

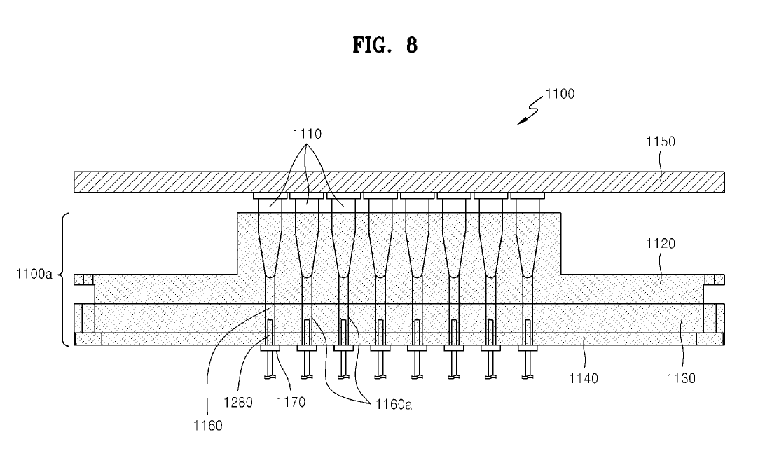

FIG. 7 is a schematic view of light emitting diodes (LEDs) 1031a through 1031d emitting one-color light used as the light source 1210 in the bio-diagnosis apparatus 1010 according to an exemplary embodiment.

In the present exemplary embodiment, an LED having relatively small heat dissipation and long lifespan is used, rather than a tungsten halogen lamp or a xenon lamp having relatively high heat dissipation and short lifespan, thereby reducing production cost.

Furthermore, a fixed dichroic filter is used, rather than a rotating color filter wheel, thereby realizing a more compact illumination optical system having a variable wavelength.

The light source 1210 may include the LEDs 1031a through 1031d. Dichroic filters 1036 may be installed corresponding to the LEDs 1031a through 1031d.

A condenser lens 1035 may be disposed between the LEDs 1031a through 1031d and the dichroic filters 1036. A focusing lens 1035a may be disposed between the dichroic filters 1036 and a homogenizing lens 1037, for example, a rod lens.

The dichroic filters 1036 are spatially disposed and fixed, rather than using rotating filter wheels, and thus, the LEDs 1031a through 1031d are sequentially turned on and off, thereby constructing an illumination system capable of selecting a desired wavelength band.

Although the LEDs 1031a through 1031d have center wavelengths of 455 nm, 470 nm, 505 nm, 530 nm, 590 nm, 617 nm, 625 nm, and 656 nm, a predetermined gap between the center wavelengths must be maintained to prevent interference between neighboring wavelengths so that the bio-diagnosis apparatus 1010 uses the LEDs 1031a through 1031d.

The condenser lens 1035 for converting emission light generated from the LEDs 1031a through 1031d into parallel light may be disposed on the LEDs 1031a through 1031d. The homogenizing lens 1037, for example, the rod lens, may homogenize a Gaussian distribution of light intensity generated from the focusing lens 1035a.

Therefore, different cut-on wavelengths of the dichroic filters 1036 are selected with respect to the center wavelengths of the LEDs 1031a through 1031d, thereby constructing a fixed wavelength variable optical engine. Thus, light of a desired wavelength band can be selectively generated without using the rotating filter wheel.

The light detection unit 1300 may detect emission light generated from a sample. To this end, the light detection unit 1300 may include an image sensor 1310, lenses 1320, a field lens 1330, and a second wavelength selection filter 1340.

The image sensor 1310 receives the emission light radiated from the samples contained in the tubes 1110, and generates an electrical signal corresponding to the emission light. The field lens 1330 and the lenses 1320 collimate the emission light in the image sensor 1310. The second wavelength selection filter 1340 blocks excitation light and transmits the emission light only, thereby minimizing an effect of noise.

The light detection unit 1300 may include a plurality of field lenses 1330. In the present exemplary embodiment, the field lens 1330 includes a first field lens 1331 and a second field lens 1332, thereby reducing a length of the optical system. Thus, a space for constructing the optical system may be reduced.

The bio-diagnosis apparatus 1010 (FIG. 6) may further include a top cover 1150 that covers the tubes 1110 from the other side of the thermoelectric device block 1100a and heats the tubes 1110. The top cover 1150 may maintain a predetermined temperature by heating the tubes 1110 during a temperature change period for nucleic acid amplification, thereby preventing a liquid sample from being evaporated and blurred during the nucleic acid amplification which interrupts detection of the emission light.

The top cover 1150 may apply pressure to the tubes 1110 so that the thermoelectric device block 1100a can strongly press the tubes 1110 during the nucleic acid amplification. Thus, thermal conductivity between the tubes 1110 and the thermoelectric device block 1100a can be increased during the nucleic acid amplification.

FIG. 8 is a schematic view of the thermal cycling unit 1100 of the bio-diagnosis apparatus 1010 according to an exemplary embodiment.

Referring to FIG. 8, the thermal cycling unit 1100 may include the thermoelectric device block 1100a and the top cover 1150. The thermoelectric device block 1100a may enable the tubes 1110 to be contained and set a temperature condition for nucleic acid amplification. The top cover 1150 covers the tubes 1110 on the thermoelectric device block 1100a and heats the tubes 1110.

Thorough holes 1160a may be formed in the thermoelectric device block 1100a to pass therethrough. The number of the thorough holes 1160a may be the same as that of the tubes 1110. The tubes 1110 may be inserted in the thorough holes 1160a from the other side of the thermoelectric device block 1100a. Transparent resin units 1160 may be formed by filling a transparent material in regions of the thorough holes 1160a excluding regions in which the tubes 1110 are inserted.

Excitation light incident through each of the optical fiber bundles 1280 may be directly incident into the tubes 1110 in which samples are contained through the thorough holes 1160a. Thus, the excitation light incident through each of the optical fiber bundles 1280 may be transferred to the tubes 1110 without any loss. To this end, a part of the optical fiber bundles 1280, for example, end points, may be inserted into the thorough holes 1160a from the one side of the thermoelectric device block 1100a.

The transparent resin units 1160a may be formed of ultra violet (UV) hardening and/or thermal hardening resin. The transparent resin units 1160 may guide excitation light incident through the optical fiber bundles 1280 and prevent impurities from being filled in the thorough holes 1160a. Lids 1170 for stopping the thorough holes 1160a may be installed at the one side of the thermoelectric device block 1100a, for example, a surface into which the optical fiber bundles 1280 are inserted. The lids 1170 may support the optical fiber bundles 1280 inserted into the thorough holes 1160a and prevent impurities from being introduced into the thorough holes 1160a.

The lids 1170 may also be applied when the transparent resin units 1160 are not formed in the thorough holes 1160a. In this case, impurities can be prevented from being introduced into the thorough holes 1160a.

Meanwhile, the thermoelectric device block 1100a may include a support block 1120, a heating block 1130, and a cooling block 1140.

The support block 1120 may be disposed on the other side of the thermoelectric device block 1100a and contact at least a part of the tubes 1110. The heating block 1130 may include a thermoelectric device and have one surface contacting the support block 1120. The cooling block 1140 may have one surface contacting the heating block 1130.

Meanwhile, the tubes 1110 may be formed of a transparent plastic material or a glass material so that light can be transmitted through the tubes 1110. Nucleic acid samples to be amplified may be contained in the tubes 1110. At least a part of the tubes 1110, for example, bottom portions, may be supported by the support block 1120.

Heat of a certain temperature is applied to the tubes 1110 from the heating block 1130 through the support block 1120. To this end, the tubes 1110 may be formed of a material having appropriate thermal conductivity. For example, the support block 1120 may be formed of aluminum (Al) having appropriate mechanical intensity and good thermal conductivity.

However, the inventive concept is not limited thereto, and the tube 1110 may directly contact the heating block 1130 to apply the heat thereto.

The heating block 1130 may include a thermoelectric device like a Peltier device to heat or cool the tubes 1110 in accordance with a period necessary for nucleic acid amplification. However, the inventive concept is not limited thereto, and the heating block 1130 may be manufactured to operate as an isothermal block and may be used to implement an isothermal target and probe amplification.

The Peltier device is a thermoelectric conversion device using the Peltier effect that uses a thermoelectric phenomenon in which heat is generated or absorbed in a bonding portion of two types of metals when current is applied to the two types of metals.

The heating block 1130 may be connected to an additionally installed controller (not shown in FIG. 8), corresponding to the controller 122 of FIG. 2, that may control a temperature to implement a temperature cycle necessary for the nucleic acid amplification.

That is, the controller applies current to the thermoelectric device of the heating block 1130 like the Peltier device through an electric wire, which may increase or reduce a temperature of the thermoelectric device, thereby controlling the temperatures of the tubes 1110. The controller may be implemented as, for example, a semiconductor chip or a circuit board using the semiconductor chip. A temperature sensor, such as the temperature sensor 127 of FIG. 2, may be installed in the thermoelectric device. The controller may control the temperature of the thermoelectric device based on a detection signal of the temperature sensor.

The cooling block 1140 contacts the heating block 1130 and externally dissipates heat of the heating block 1130, thereby controlling the temperature of the heating block 1130. The cooling block 1140 transfers the heat generated from the heating block 1130 to the outside, thereby supplementing quick cooling.

The cooling block 1140 may further include a heat sink, such as the heat sink 130 of FIG. 2, formed of a heat transfer material which contacts one surface of the heating block 1130. The heat sink may be formed of a thermoelectric metal such as aluminum or copper. The heat sink can achieve a cooling effect using a natural convection effect. The heat sink may use a structure of a heat pipe.

The cooling block 1140 may introduce various technologies to supplement the cooling effect. For example, an air supplying unit for supplying air or a cooling pipe through which cooling fluid flows may be installed in the cooling block 1140.

That is, the cooling effect of the heating block 1130 is maximized by using the cooling block 1140, thereby facilitating adjustment of the temperature of the heating block 1130.

The top cover 1150 maintains a predetermined temperature by heating the tubes 1110 during the thermal cycling period for the nucleic acid amplification, and may apply pressure to the tubes 1110 so that the thermoelectric device block 1100a can strongly press the tubes 1110.

The top cover 1190 may prevent a liquid sample from being evaporated and blurred during the nucleic acid amplification which interrupts detection of the emission light. The top cover 1190 may also contribute to increasing thermal conductivity between the tubes 1110 and the thermoelectric device block 1100a.

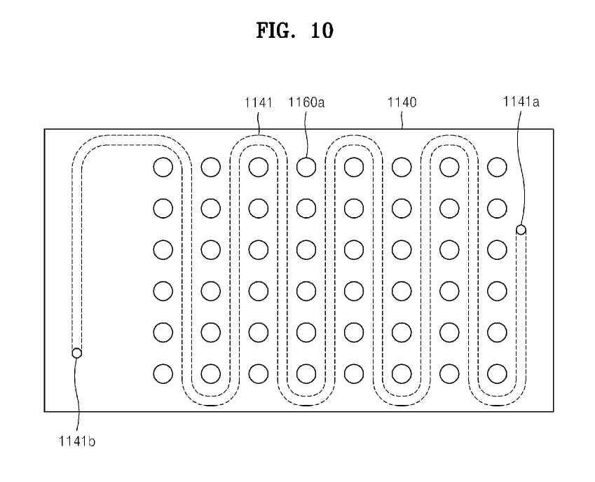

FIG. 9 is an exploded perspective view of a bio-diagnosis apparatus 1040 that is cooled by using an additionally installed circulating fluid cooling system according to an exemplary embodiment. FIG. 10 is a schematic diagram of a heat pipe 1141 installed in the cooling block 1140 of the bio-diagnosis apparatus 1040 according to an exemplary embodiment.

The bio-diagnosis apparatus 1040 of the present exemplary embodiment further includes a cooling unit 1400 compared to the bio-diagnosis apparatus 1010 of FIG. 6, and thus, the like reference numerals denote like elements, and the detailed descriptions thereof will be omitted here.

When the thorough holes 1160a are formed in the thermoelectric device block 1100a as shown in FIG. 10, a cooling contact area of the thermoelectric device block 1100a is reduced by as much as the volume of the thorough holes 1160a. Accordingly, cooling efficiency may be reduced.

However, the bio-diagnosis apparatus 1040 of the present exemplary embodiment applies the circulating fluid cooling system and accelerates a cooling rate of the cooling unit 1400 by using cool water or cooling fluid, thereby increasing cooling efficiency.

The bio-diagnosis apparatus 1040 may include the thermal cycling unit 1100, the light generation unit 1200, the light detection unit 1300, and the cooling unit 1400. The cooling unit 1400 cools the thermal cycling unit 1100.

The cooling unit 1400 is connected to the cooling block 1140 of the thermal cycling unit 1100 and cools the cooling block 1140 through which the heating block 1130 is cooled, and thus, the tubes 1110 where samples are contained can be cooled.

The heat pipe 1141 where thermal transfer fluid flows may be disposed through the cooling block 1140. That is, the thermal transfer fluid may absorb heat of the cooling block 1140 and dissipate the heat to the outside through the heat pipe 1141.

The cooling unit 1400 is an implementation of the circulating fluid cooling system and may circulate the thermal transfer fluid and cool the cooling block 1140. In this regard, to proceed PCR, the temperature of the thermoelectric device block 1100a may be controlled so that a heating rate is 4-5° C./sec and a cooling rate is −2-3° C./sec while a whole temperature uniformity of the heating block 1130 is maintained within ±0.5° C.

The cooling unit 1400 may include a recovery flow path 1410, a supply flow path 1420, and a pump 1430. The recovery flow path 1410 is connected to a fluid outlet 1141b of the heat pipe 1141 and recovers the thermal transfer fluid to the outside. The supply flow path 1420 is connected to a fluid inlet 1141a of the heat pipe 1141 and supplies the thermal transfer fluid to the inside. The pump 1430 operates to supply or recover the thermal transfer fluid to or from the heat pipe 1141.

If the heating block 1130 is heated to proceed PCR, the heat of the heating block 1130 may be transferred to the cooling block 1140. The heat is transferred to the heat pipe 1141 of the cooling block 1140 and then to the thermal transfer fluid of the heat pipe 141, and thus, the thermal transfer fluid is heated.

The thermal transfer fluid heated in the heat pipe 1141 is discharged to the outside through the recovery flow path 1410 connected to the fluid outlet 1141b. The thermal transfer fluid discharged to the outside is cooled. The cooled thermal transfer fluid is supplied to the heat pipe 1141 through the supply flow path 1420 and then the fluid inlet 1141a. Accordingly, the cooling block 1140 may be cooled through the heat pipe 1141.

The cooling unit 1400 may further include a thermoelectric device 1440 that thermally exchanges the thermal transfer fluid recovered through the recovery flow path 1410. The cooling unit 1400 may include an additional heat pipe used to thermally exchange the thermal transfer fluid recovered through the recovery flow path 1410 with the thermoelectric device 1440.

The additional heat pipe may be configured to directly or indirectly contact the thermoelectric device 1440. Thus, the heated thermal transfer fluid may be cooled through the thermoelectric device 1440 disposed outside.

The cooling unit 1400 may include a cooling fan 1450 for cooling the thermal transfer fluid recovered through the recovery flow path 1410. The cooling fan 1450 may be used to externally dissipate the heat of the thermal transfer fluid recovered through the recovery flow path 1410.

Cooling water or another refrigerant may be used as the thermal transfer fluid. However, the inventive concept is not limited thereto, and various types of thermal transfer fluid may be used.

During increase in the temperature of the heating block 1130 as PCR progresses, the temperature of the thermal transfer fluid may be reduced by the thermoelectric device 1440 included in the cooling unit 1400, and the cooled thermal transfer fluid may be transferred to the cooling block 1140 by the pump 1430 through the supply flow path 1420 when the heating block 1130 needs to be cooled.

Accordingly, the heating block 1130 may be efficiently cooled when cooling of a sample is necessary during PCR.

The first wavelength selection filter 1260 of the light generation unit 1200 may be implemented as a filter wheel 1260′ as shown in FIG. 9. Thus, the filter wheel 1260′ may be adjusted, and thus excitation light of various different wavelength bands can be selectively generated.

The lenses 1320 and the field lens 1330 of the light detection unit 1300 may be implemented as a telecentric camera. Thus, the same amount of the excitation light can be detected from the image sensor 1310, irrespective of a distance of the image sensor 1310 at which emission light generated from a sample arrives.

The second wavelength selection filter 1340 of the light detection unit 1300 may be implemented as a filter wheel 1340′ as shown in FIG. 9. Thus, the filter wheel 1340′ may be adjusted, and thus, emission light of various different wavelength bands may be selectively generated.

The optical fiber bundles 1280 applied to the light generation unit 1200 may be reflected, thereby freely constructing a structure of an optical system. In the present exemplary embodiment, the light generation unit 1200 may be in parallel to the light detection unit 1300 that is disposed right on the thermal cycling unit 1100, thereby reducing a space for constructing the optical system used to detect nucleic acid amplification.

The bio-diagnosis apparatus 1040 of the present exemplary embodiment is not limited to the thermal cycling unit 1100, the reaction detection optical system using optical fiber, and/or the cooling unit 1400 using a circulating fluid cooling method described above. However, these technical constructions may be applied to isothermal target and probe amplification or other real-time emission light detection equipment and a real-time bio-diagnosis apparatus capable of DNA or RNA real-time quantitative detection for an amplification process as well.

According to the present exemplary embodiment, the optical fiber bundles 1280 are used to irradiate uniform light onto samples, thereby increasing illumination light efficiency.

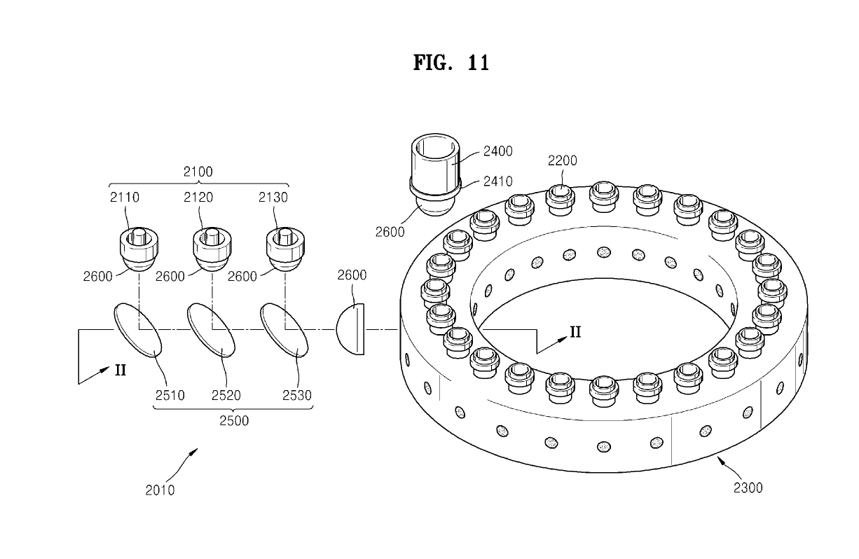

A bio-diagnosis apparatus according to other exemplary embodiments will be described in detail with reference to FIGS. 11-19. Each of the exemplary embodiments may be implemented by interchangeably using components constituting another one of the exemplary embodiments.

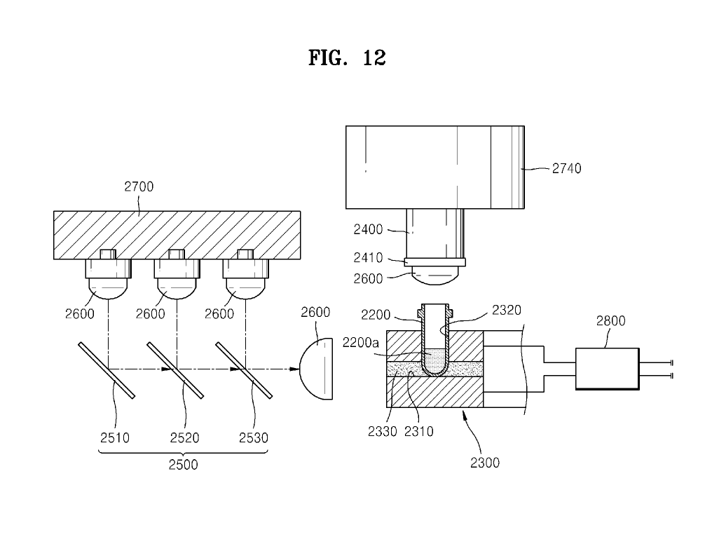

FIG. 11 is a schematic view of a bio-diagnosis apparatus 2010 according to another exemplary embodiment. FIG. 12 is a cross-sectional view taken along a line II-II of the bio-diagnosis apparatus 2010 of FIG. 11.

Referring to FIGS. 11 and 12, the bio-diagnosis apparatus 2010 may include a light generation unit 2100, tubes 2200, a thermoelectric device block 2300, and a light detection unit 2400.

The light generation unit 2100 may output excitation light from LED light sources 2110, 2120, and 2130. The excitation light may be transmitted into the tubes 220 containing samples. The bio-diagnosis apparatus 2010 may include at least one tube 2200.

A plurality of optical transmissive holes 2310 are formed in the thermoelectric device block 2300 from one surface thereof to the at least one tube 2200. The thermoelectric device block 2300 may support the at least one tube 2200 and at least one part of the at least one tube 2200 is exposed from another surface abutting the one surface thereof. The light detection unit 2400 may detect emission light generated in samples 2200a by excitation light incident through the light transmissive holes 2310 from above the other surface of the thermoelectric device block 2300.

The bio-diagnosis apparatus 2010 may allow light paths of the excitation light irradiated onto the samples 2200a and the emission light generated therefrom to form a predetermined angle. Therefore, the bio-diagnosis apparatus 2010 may reduce an amount of the excitation light that arrives at the light detection unit 2400 that detects the emission light.

The samples 2200a contained in the at least one tube 2200 may be controlled to have a predetermined temperature cycle or may be maintained at a predetermined temperature through the thermoelectric device block 2300. Accordingly, nucleic acid of the samples 2200a may be amplified by using PCR of nucleic acid amplification based technology.

As an amplification reaction of the samples 2200a proceeds, the excitation light may be irradiated onto the samples 2200a, and the emission light generated therefrom may be detected in real time.

The excitation light output from the light generation unit 2100 may arrive at the samples 2200a contained in the at least one tube 2200 through the light transmissive holes 2310. The light detection unit 2400 may detect the emission light generated by irradiating the excitation light onto the samples 2200a.

The bio-diagnosis apparatus 2010 that uses the PCR of the nucleic acid amplification based technology may amplify nucleic acid by using a thermal cycler including the thermoelectric device block 2300 that may use the Peltier effect.

The light paths of the excitation light and the emission light may be partially exchanged in view of the construction of an optical system. Thus, the majority of the excitation light may be transmitted into the light detection unit 240. In general, the excitation light may be brighter about 104-105 times than the emission light. Thus, if both the excitation light and the emission light are transmitted into the light detection unit 2400, a signal to noise ratio (SNR) is very low, which makes it difficult to detect normal emission light.

The bio-diagnosis apparatus 2010 allows the light paths of the excitation light irradiated onto the samples 2200a and the emission light generated therefrom to form a predetermined angle, thereby reducing the amount of the excitation light arriving at the light detection unit 2400.

The thermoelectric device block 2300 contacts the at least one tube 2200, and a temperature of the thermoelectric device block 2300 is controlled, thereby controlling the temperature of the samples 2200a contained in the at least one tube 2200. The bio-diagnosis apparatus 2010 may amplify nucleic acid through PCR. The bio-diagnosis apparatus 2010 may amplify the nucleic acid by cycling the temperature of the samples 2200a from 60° C. to 95° C.

The bio-diagnosis apparatus 2010 may amplify the nucleic acid by maintaining the temperature of the samples 2200a at about 60° C. by using a nucleic acid amplification reagent. In this case, a temperature control device including the thermoelectric device block 2300 may be an isothermal control device.

The bio-diagnosis apparatus 2010 may include the light generation unit 2100, the thermoelectric device block 2300, and the light detection unit 2400 in such a way that the light paths of the excitation light irradiated onto the samples 2200a and the emission light generated therefrom form a predetermined angle, for example, a right angle.

The thermoelectric device block 2300, as shown in FIG. 11, may have a shape of cylinder having a predetermined thickness. At least one support hole 2320, for example, a plurality of support holes 2320, may be formed from a top surface of the thermoelectric device block 2300 along a circumference of the cylinder. The at least one tube 2200 may be supported by being inserted into the at least one hole 2320.

The light transmissive holes 2310 may be formed in side surfaces of the thermoelectric device block 2300 through a thickness direction of the cylinder along the circumference thereof toward the center thereof. However, the inventive concept is not limited thereto, and the light transmissive holes 2310 may be formed in such a way that inner parts of the light transmissive holes 2310 are closed. The light transmissive holes 2310 may be disposed in the thermoelectric device block 2300 to form a circle with respect to a virtual axis.

Each of the light transmissive holes 2310 may be connected to each of the at least one support hole 2320 formed from the top surface of the thermoelectric device block 2300, and a bottom portion of the at least one tube 2200 may be exposed through the light transmissive holes 2310. Thus, the excitation light incident from an outer surface may arrive at the samples 2200a contained in the at least one tube 2200.

As shown in FIG. 12, the light transmissive holes 2310 may be formed in the thermoelectric device block 2300 to form a right angle with the at least one support hole 2320, respectively. Thus, the excitation light incident through the light transmissive holes 2310 arriving at the light detection unit 2400 through the at least one support hole 2320 may be interrupted.

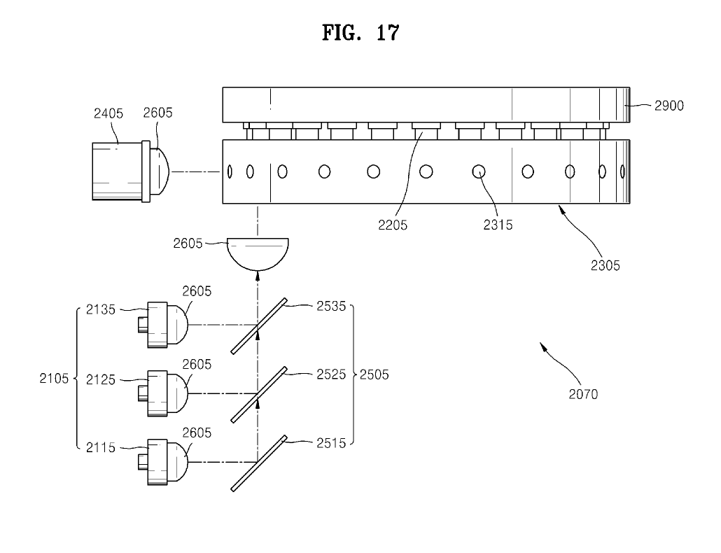

However, the inventive concept is not limited thereto, and a light transmissive hole 2311 may be formed in a thermoelectric device block 2301 to form an acute angle with a support hole 2321, as shown in FIG. 16. Thus, an input and output angle 2060 between incident excitation light 2061 and exiting emission light 2062 may be the acute angle.

In this case, it may be difficult for the excitation light 2061 incident through the light transmissive holes 2311 to arrive at the light detection unit 2400 through the support hole 2321. Thus, an amount of the excitation light 2061 incident through the light transmissive holes 2311 and arriving at the light detection unit 2400 through the support hole 2321 may be reduced.

The numbers of the light transmissive holes 2310 and the at least one support hole 2320 that are formed in the thermoelectric device block 2300 may be the same. The light transmissive holes 2310 and the at least one support hole 2320 may respectively correspond to each other. The thermoelectric device block 2300 can be rotated.

A cable for power supply or signal transfer may be connected to the thermoelectric device block 2300 for operation thereof. In this case, the cable may be twisted when the thermoelectric device block 2300 is rotated. Thus, the bio-diagnosis apparatus 2010 may include a slip ring 2800.

The slip ring 2800 may connect an input line and/or an output line connected to the thermoelectric device block 2300 to the outside in a rotatable state. In this case, the slip ring 2800 may prevent a cable of the input line and/or the output line from being twisted.

The light generation unit 2100 and the light detection unit 2400 may be disposed in fixed positions. The light transmissive holes 2310 may be disposed in the thermoelectric device block 2300 to form a circle with respect to a virtual rotational axis of the thermoelectric device block 2300.

The thermoelectric device block 2300 may rotate in such a way that the light transmissive holes 2310 may be sequentially positioned corresponding to the excitation light input from the light generation unit 2100. The thermoelectric device block 2300 may rotate in such a way that the light generation unit 2100 and the light detection unit 2400 may correspond to the light transmissive holes 2310 and the at least one support hole 2320.

The light generation unit 2100 may output the excitation light from the LED light sources 2110, 2120, and 2130. The light generation unit 2100 may include the LED light sources 2110, 2120, and 2130 that respectively output one-color light. The LED light sources 2110, 2120, and 2130 may be spaced in parallel apart from each other.

The LED light sources 2110, 2120, and 2130 may generate heat. The heat may change the characteristics of the excitation light generated from the LED light sources 2110, 2120, and 2130. Thus, the bio-diagnosis apparatus 2010 may include a first cooling module 2700 that supports at least one of the LED light sources 2110, 2120, and 2130 and cools the LED light sources 2110, 2120, and 2130.

The LED light sources 2110, 2120, and 2130 may be mounted in the first cooling module 2700. The first cooling module 2700 may simultaneously cool the LED light sources 2110, 2120, and 2130. Thus, the first cooling module 2700 can simultaneously cool a plurality of light sources, and reduce the volume, weight, and cost of the bio-diagnosis apparatus 2010.

The LED light sources 2110, 2120, and 2130 are spaced in parallel apart from each other, and thus, the LED light sources 2110, 2120, and 2130 can be easily mounted in the first cooling module 2700. Thus, a limited number of cooling modules, i.e., the first cooling module 2700, can simultaneously cool the LED light sources 2110, 2120, and 2130, and reduce the volume, weight, and cost of the bio-diagnosis apparatus 2010.

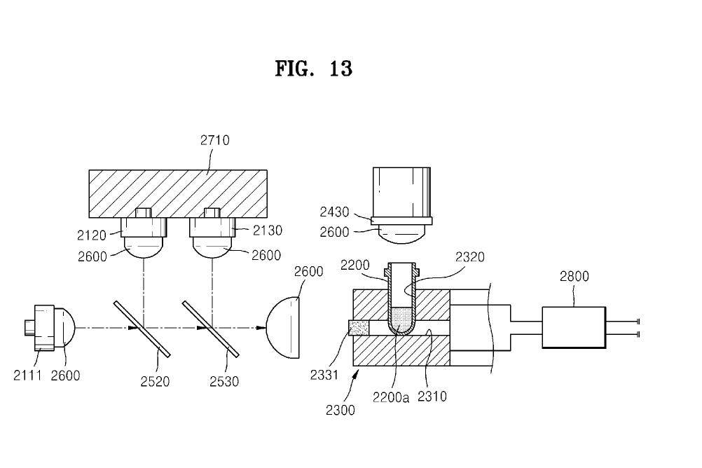

However, the inventive concept is not limited thereto. Referring to FIG. 13, the light generation unit 2100 may include LED light sources 2111, 2120, and 2130, allow the LED light sources 2120 and 2130, except the LED light source 2111, to be parallel installed in a first cooling module 2710, and simultaneously cool the LED light sources 2120 and 2130 by using the LED light source 2110.

The at least one tube 2200 may be formed of a light transmissive material through which the excitation light can be transmitted. The at least one tube 2200 can be respectively contained in the at least one support hole 2320. That is, samples are contained in the at least one tube 2200, and a predetermined temperature cycle or a predetermined temperature is maintained by using the thermoelectric device block 2300, and thus, nucleic acid amplification may occur in the samples.

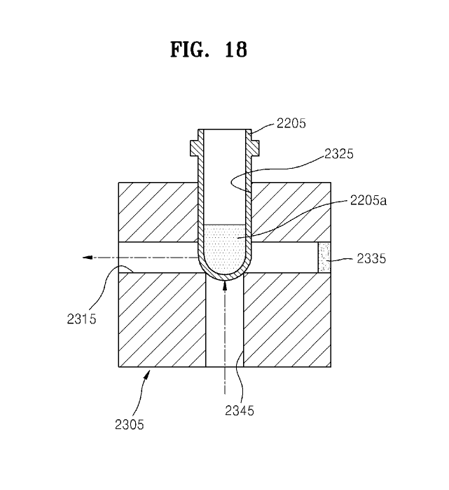

The at least one tube 2200 may surface-contact the thermoelectric device block 2300 and may be tightly supported by the thermoelectric device block 2300. A top cover 2900 may be disposed on the top surface of the thermoelectric device block 2300 as shown in FIG. 17 so that the at least one tube 2200 may tightly contact the support hole 2320 of the thermoelectric device block 2300. The top cover 2900 may be installed to apply pressure to the at least one tube 2200 in a downward direction.

Referring back to FIG. 11, the light generation unit 2100 may include the first through third LED light sources 2110, 2120, and 2130 that are spaced in parallel apart from each other. The first through third LED light sources 2110, 2120, and 2130 may be spaced apart from the thermoelectric device block 2300.

The first through third LED light sources 2110, 2120, and 2130 are sequentially disposed with respect to the thermoelectric device block 2300. That is, the second LED light source 2120 may be disposed closer to the thermoelectric device block 2300 than the first LED light source 2110, and the third LED light source 2130 may be disposed closer to the thermoelectric device block 2300 than the second LED light source 2120.

The bio-diagnosis apparatus 2010 may include a filter unit 2500 that reflects and/or transmits the incident excitation light and guides the excitation light to the light transmissive holes 2310, for example, as shown in FIG. 12. The filter unit 2500 may include a first filter 2510, a second filter 2520, and a third filter 2530.

The first filter 2510 may reflect the excitation light output from the first LED light source 2110 to the light transmissive holes 2310. The second filter 2520 may reflect the excitation light output from the second LED light source 2120 to the light transmissive holes 2310. The third filter 2530 may reflect the excitation light output from the third LED light source 2130 to the light transmissive holes 2310.

The second filter 2520 may transmit at least a part of the excitation light output from the first LED light source 2110. The third filter 2530 may transmit at least a part of the excitation light output from the first LED light source 2110 and the second LED light source 2120.

The first LED light source 2110, the second LED light source 2120, and the third light source 2130 may be LED light sources that output red, green, and blue one-color light, respectively. The first filter 2510, the second filter 2520, and the third filter 2530 may be dichroic filters. A dichroic filter reflects a wavelength shorter than a specific wavelength, and transmits (or receive) a wavelength longer than the specific wavelength.

Therefore, the first LED light source 2110, the second LED light source 2120, and the third light source 2130 are sequentially turned on and off so that excitation light having different wavelengths can be sequentially incident from the first LED light source 2110, the second LED light source 2120, and the third light source 2130 through the same light transmissive hole 2310. In this case, the excitation light having different wavelengths incident through the same light transmissive hole 2310 are sequentially irradiated into the samples 2200a of the same tube 2200, thereby generating emission light.

If the light detection unit 2400 detects emission light of one of the at least one tube 2200 generated from the excitation light from the first LED light source 2110, the second LED light source 2120, and the third light source 2130, the thermoelectric device block 2300 rotates, and the excitation light is irradiated onto the samples 2200a of another tube 2200, thereby generating another emission light.

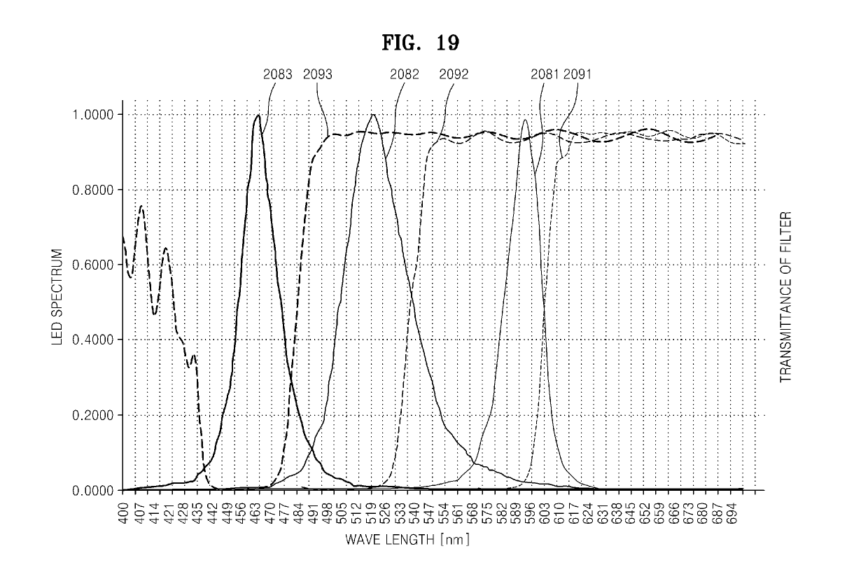

FIG. 19 shows characteristics of spectrum 2081, 2082, and 2083 of the first LED light source 2110, the second LED light source 2120, and the third light source 2130, and corresponding transmittances 2091, 2092, and 2093 of the first filter 2510, the second filter 2520, and the third filter 2530 corresponding to the first LED light source 2110, the second LED light source 2120, and the third light source 2130 as shown in FIG. 11.

Referring to FIGS. 11 and 19, the third LED light source 2130 having a center wavelength of 470 nm is used as an absorption wavelength of an emission reagent FAM, and thus, is paired with the third filter 2530. The second LED light source 2120 having a center wavelength of 528 nm is used as an absorption wavelength of an emission reagent JOE, and thus, is paired with the second filter 2520. The first LED light source 2110 having a center wavelength of 590 nm is used as an absorption wavelength of an emission reagent carboxy-X-rhodamine (ROX), and thus, is paired with the first filter 2510.

The pairs of the first filter 2510, the second filter 2520, and the third filter 2530 and the first LED light source 2110, the second LED light source 2120, and the third light source 2130, respectively, are arranged so that the first LED light source 2110 having the longest wavelength is positioned far left, and the third LED light source 2130 having the shortest wavelength is positioned far right.

Therefore, the first filter 2510 may reflect the excitation light output from the first LED light source 2110. The second filter 2520 may transmit at least a part of the excitation light output from the first LED light source 2110 and reflect the excitation light output from the second LED light source 2120. The third filter 2530 may transmit at least a part of the excitation light output from the first LED light source 2110 and the second LED light source 2120 and reflect the excitation light output from the third LED light source 2130.

That is, the first LED light source 2110, the second LED light source 2120, and the third light source 2130 are spaced in parallel apart from each other, and are reflected and/or transmitted by using the first filter 2510, the second filter 2520, and the third filter 2530, thereby removing a heavy and voluminous filter wheel.

According to another exemplary embodiment as illustrated in FIG. 13, one of the first LED light source 2110, the second LED light source 2120, and the third light source 2130, for example, the first LED light source 2110, may be disposed in such a way that the excitation light output therefrom is directed toward the light transmissive holes 2310.

That is, the first LED light source 2110 may be disposed in such a way that the excitation light output therefrom directly enters the light transmissive holes 2310 without changing a light path due to a filter. In this case, in the exemplary embodiment of FIGS. 11 and 12, the first filter 2510 for reflecting the excitation light output from the first LED light source 2110 and changing the light path may not be necessary, thereby implementing the bio-diagnosis apparatus 2010 having less number of parts.

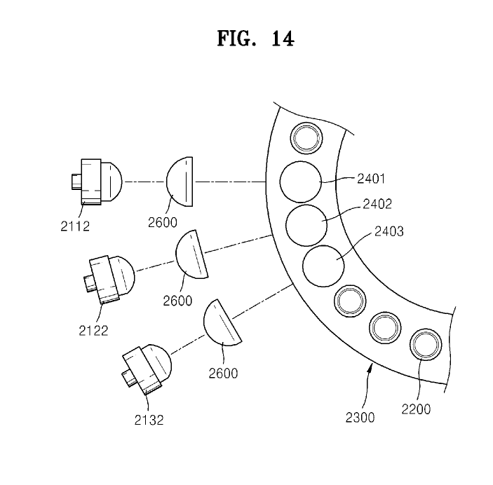

Referring to FIG. 14, a first LED light source 2112, a second LED light source 2122, and a third light source 2132 may be disposed corresponding to different light transmissive holes along a circumferential line of the thermoelectric device block 2300. For example, a light generation unit may include the first LED light source 2112, the second LED light source 2122, and the third light source 2132, and the first LED light source 2112, the second LED light source 2122, and the third light source 2132 may be disposed corresponding to different light transmissive holes.

In this case, excitation light output from the first LED light source 2112, the second LED light source 2122, and the third light source 2132 may be directly incident into light transmissive holes without using an additional filter changing a light path. Thus, the filter unit 2500 of FIG. 11 used to change the light path and/or separate light for each wavelength may not be necessary.

In this case, the light detection unit 2400 may include a first light sensor 2401, a second light sensor 2402, and a third light sensor 2403 that are disposed on or above the at least one tube 2200 along the circumferential line of the thermoelectric device block 2300.

In this case, the first light sensor 2401, the second light sensor 2402, and the third light sensor 2403 detect emission light generated from excitation light output from the first LED light source 2112, the second LED light source 2122, and the third light source 2132, respectively.

The emission light may be simultaneously output from the first LED light source 2112, the second LED light source 2122, and the third light source 2132, and the first light sensor 2401, the second light sensor 2402, and the third light sensor 2403 may detect the emission light, respectively. Thus, the excitation light may not be sequentially output from the first LED light source 2112, the second LED light source 2122, and the third light source 2132 as shown in FIG. 11. In this case, the emission light can be detected more quickly from the samples 2200a of the at least one tube 2200 contained in the thermoelectric device block 2300.

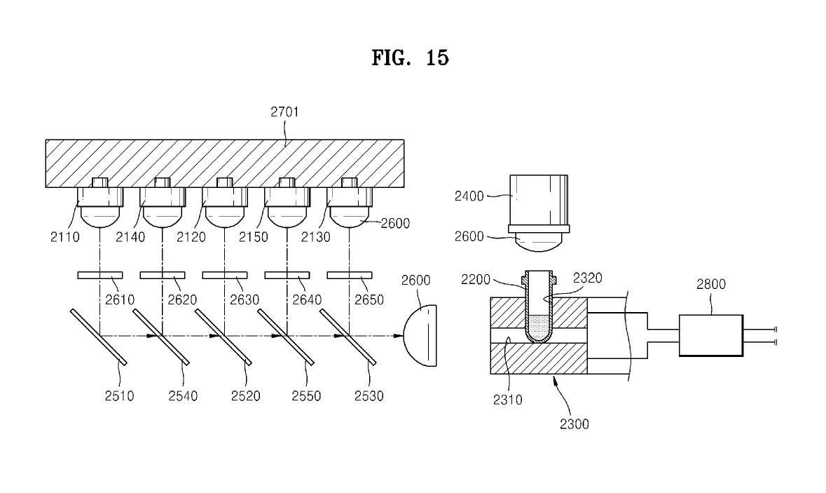

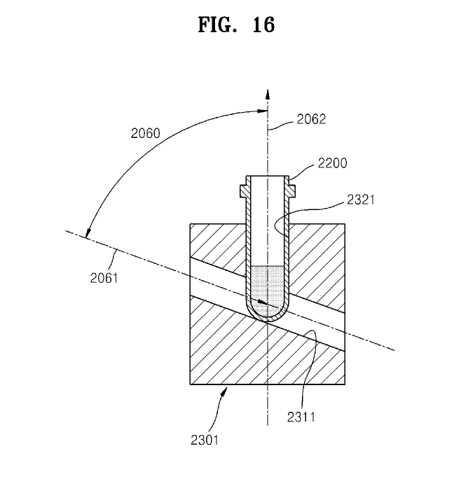

Referring to FIG. 15, the bio-diagnosis apparatus 2010 may further include a fourth LED light source 2140 and/or a fifth LED light source 2450. In this case, the fourth LED light source 2140 and the fifth LED light source 2450 may be disposed between the first LED light source 2112 and the second LED light source 2122, and between the second LED light source 2122 and the third light source 2132, respectively. The fourth LED light source 2140 and the fifth LED light source 2450 may output excitation light having an intermediate band wavelength of the first LED light source 2112 and the second LED light source 2122, and excitation light having an intermediate band wavelength of the second LED light source 2122 and the third light source 2132, respectively.

A fourth filter 2504 may be disposed corresponding to the fourth LED light source 2140. A fifth filter 2505 may be disposed corresponding to the fifth LED light source 2150.

In this case, in the graph of FIG. 19, a wavelength band of the excitation light output from the fourth LED light source 2140 may be disposed between the spectrum 2081 of the first LED light source 2110 and the spectrum 2082 of the second LED light source 2120. Accordingly, in the graph of FIG. 19, a spectrum of the fourth LED light source 2140 may overlap with the spectrum 2081 of the first LED light source 2110 and the spectrum 2082 of the second LED light source 2120.

Also, in the graph of FIG. 19, a wavelength band of the excitation light output from the fifth LED light source 2150 may be disposed between the spectrum 2082 of the second LED light source 2120 and the spectrum 2083 of the third LED light source 2130.

Accordingly, a spectrum of the fifth LED light source 2150 may overlap with the spectrum 2082 of the second LED light source 2120 and the spectrum 2083 of the third LED light source 2130.

Thus, band pass filters 2610 through 2650 for passing a specific band may be disposed between the first through fifth LED light sources 2110, 2120, 2130, 2140, and 2150, and the first through fifth filters 2510, 2520, 2530, 2540, and 2550.

According to FIGS. 12 and 12, the light detection unit 2400 may detect the emission light generated from the sample 2200a by using the excitation light incident into the light transmissive holes 2310. The light detection unit 2400 may detect the emission light generated from the samples 2200a by using the excitation light. The light detection unit 2400 may include a photo diode, and detect the emission light through the photo diode.

The bio-diagnosis apparatus 2010 can be lightweight and small-sized by using a simple and small photo diode. However, the inventive concept is not limited thereto, and the light detection unit 2400 may include a charge coupled device (CCD) or a photomultiplier tube (PMT) detector having excellent sensitivity to weak light. The light detection unit 2400 may use a photo diode array microchannel plate PMT in order to more quickly measure various wavelength regions simultaneously.

Sensing characteristics of the light detection unit 2400 may deteriorate due to radiant heat output from the thermoelectric device block 2300. Thus, the bio-diagnosis apparatus 2010 may further include a second cooling module 2740, as shown in FIG. 12, that cools the light detection unit 2400. The second cooling module 2740 may cool the light detection unit 2400 so that the light detection unit 2400, for example, a photo diode, is not extremely heated due to its use or radiant heat output from the thermoelectric device block 2300, thereby improving the thermal characteristics of the light detection unit 2400.

According to another exemplary embodiment, a block filter 2410 or 2430 may be disposed between the at least one tube 2200 and the light detection unit 2400, as shown in FIGS. 11-13. The block filter 2410 or 2430 may be an infrared ray block filter that blocks an infrared ray output from the thermoelectric device block 2300.

According to another exemplary embodiment, referring to FIG. 13, the block filter 2430 disposed between the at least one tube 2200 and the light detection unit 2400 may be a filter that blocks a small amount of excitation light along with emission light. In this case, emission light detection performance of the light detection unit 2400 can be improved.

The block filter 2430 may be a neutral density (ND) filter. In this case, the block filter 2430 may block a small amount of the excitation light toward the light detection unit 2400 along with the emission light, and allow emission light greater than a specific intensity to pass through. In this case, several expensive band pass filters may not be used.

A part of the excitation light may arrive at a light sensor of the light detection unit 2400 due to a reflection of the at least one tube 2200 where the samples 2200a are contained. However, even in this case, since a small amount of excitation light arrives at the light detection unit 2400, a base line value is processed through noise processing, and an emission light value is used as effective analysis data, thereby increasing analysis performance of the excitation light.

A medium for straightening the light path or optical fiber bundles may be filled in an entrance part of the light transmissive holes 2310 or at least a part thereof. The optical fiber bundles may be formed of a material having an incidence angle and/or an exiting angle of about 20 degrees.

For example, referring to FIG. 12, the straight media or the optical fiber bundles may be filled in the light transmissive holes 2310. According to another exemplary embodiment, referring to FIG. 13, the straight media or the optical fiber bundles may be filled in an entrance of the light transmissive holes 2310.

In this case, the straightness of the incident excitation light can be improved. If the incident excitation light has a high straightness, an amount of scattering light generated from boundary surfaces of the at least one tube 2200 or a collision between the at least one tube 2200 and the samples 2200a that arrive at the light sensor of the light detection unit 2400 may be reduced. If the excitation light that arrives at the light sensor of the light detection unit 2400 is dramatically reduced, a filter wheel that is disposed before the light sensor and is necessary for blocking interferences of the excitation light and the emission light can be removed.

Condenser lenses 2600 may be disposed between the first through third LED light sources 2110, 2120, and 2130 and the first through third filters 2510, 2520, and 2530, between the filter unit 2500 and the light transmissive holes 2310, and between the at least one tube 2200 and the light detection unit 2400. The condenser lenses 2600 may collimate incident light.

The bio-diagnosis apparatus 2010 may implement an isothermal target and probe amplification device as a small optical system including a rotating isothermal thermoelectric device block, LED light sources, condenser lenses, a dichroic filter, and a photo diode. Thus, the bio-diagnosis apparatus 2010 may dramatically reduce volume, weight, and/or cost compared to a poikilothermic target & probe amplification device.

Therefore, the bio-diagnosis apparatus 2010 of the exemplary embodiments may be easily purchased by a small-scale medical institution. In addition, since the bio-diagnosis apparatus 2010 of the exemplary embodiments may provide an easy use and a prompt diagnosis result, it may also be adopted by a large-scale food service facility or at a place requiring an emergency treatment.

Since the light generation unit 2100 uses LED light sources rather than tungsten halogen lamps, and thus, the bio-diagnosis apparatus 2010 can reduce its price while increasing its lifetime. The LED light sources are arranged in parallel to each other, thereby facilitating cooling of the LED light sources through a cooling device.

The bio-diagnosis apparatus 2010 may adopt a method of reading tubes one by one by using a photo diode rather than a method of irradiating an entire large area by using a CCD camera.

An amount of illumination light that directly arrives at a light sensor can be reduced by forming thorough holes in such a way that about a right angle or an acute angle is formed between a direction of the illumination light incident into a rotating thermoelectric device block and a direction by which emission light is perceived. Therefore, a rotating filter wheel necessary for the perception of the emission light may be removed.

Straightness of the illumination light incident into tubes may be increased by inserting optical fiber bundles having narrow incidence angles into light transmissive holes. In this case, an amount of scattering light generated from boundary surfaces of tubes or a collision between the tubes and samples that arrives at the light sensor may be reduced.

The light transmissive holes are formed to have oblique angles, for example, acute angles, rather than right angles, thereby further reducing an amount of the illumination light that arrives at the light sensor.

FIG. 17 is a schematic view of a bio-diagnosis apparatus 2070 according to another exemplary embodiment. FIG. 18 is a cross-sectional view of a rotating thermoelectric device block 2305 of the bio-diagnosis apparatus 2070 of FIG. 17 according to an exemplary embodiment.

Referring to FIGS. 17 and 18, the bio-diagnosis apparatus 2070 includes the rotating thermoelectric device block 2305 similar to the thermoelectric device block 2300 of FIG. 11, a light generation unit 2105 that irradiates excitation light from a bottom surface of the rotating thermoelectric device block 2305, and a light detection unit 2405 that detects emission light from side surfaces of the rotating thermoelectric device block 2305.

The bio-diagnosis apparatus 2070 uses similar reference numbers for the elements of the bio-diagnosis apparatus 2010 of FIGS. 11 through 16, and thus, detailed descriptions thereof will be omitted here.

The bio-diagnosis apparatus 2070 may include the light generation unit 2105, tubes 2205, the rotating thermoelectric device block 2305, the light detection unit 2405, a filter unit 2505, and condenser lenses 2605. The light generation unit 2105 may include a first LED light source 2115, a second LED light source 2125, and a third LED light source 2135. The filter unit 2505 may include a first filter unit 2515, a second filter unit 2525, and a third filter unit 2535.

An incidence hole 2345, an exiting hole 2315, and a support hole 2325 may be formed in the rotating thermoelectric device block 2305. The incidence hole 2345 may be formed in a bottom surface of the rotating thermoelectric device block 2305. The excitation light may be incident through the incidence hole 2345. The exiting hole 2315 may be formed in side surfaces of the rotating thermoelectric device block 2305. The emission light may be exited through the exiting hole 2315 and arrive at the light detection unit 2405.

The exiting hole 2315 may be formed in the side surfaces of the rotating thermoelectric device block 2305 as a thorough hole. In this case, a stopper 2335 may be formed at one end of the thorough hole disposed at a side of a rotational axis of the rotating thermoelectric device block 2305. The stopper 2335 may block the emission light from exiting in a direction of the rotational axis of the rotating thermoelectric device block 2305.

In this case, a top surface of the rotating thermoelectric device block 2305 where the tubes 2305 are contained may spatially have a degree of freedom. Thus, a top cover 2900 may be disposed on the top surface of the rotating thermoelectric device block 2305. The top cover 2900 may cover the tubes 2205 inserted into the rotating thermoelectric device block 2305 and press the tubes 2205 from the top surface of the rotating thermoelectric device block 2305.

Therefore, the tubes 2205 may surface-contact the rotating thermoelectric device block 2305 and be tightly supported by the rotating thermoelectric device block 2305. Thus, a temperature change in the rotating thermoelectric device block 2305 may be effectively transferred to the tubes 2205, thereby facilitating temperature control of samples 2205a contained in the tubes 2205.

The bio-diagnosis apparatuses 2010 and 2070 allow light paths of the excitation light irradiated onto the samples 2200a and 2205a, respectively, and the emission light generated therefrom to form a predetermined angle, thereby reducing an amount of the excitation light that arrives at a light detection sensor that detects the emission light. However, the inventive concept is not limited to the constructions of FIGS. 11 and 18, and various other constructions are possible in such a way that the light paths of the excitation light and the emission light generated therefrom form a predetermined angle.

According to the exemplary embodiments, light paths of excitation light irradiated onto samples and emission light generated therefrom form a predetermined angle, thereby reducing an amount of the excitation light that arrives at a light detection sensor that detects the emission light.

As described above, the light transmissive temperature control apparatus and the bio-diagnosis apparatus according to the exemplary embodiments can effectively control temperatures of tubes for nucleic acid amplification and detect the nucleic acid amplification in real time since a temperature control unit for controlling temperatures of tubes where samples are contained can transmit light through tubes.

Furthermore, the light transmissive temperature control apparatus includes optical elements to reduce noise on paths of light that proceed through tubes, thereby minimizing effect caused by noise. Thus, it is unnecessary to change paths of light or configure complicated optical elements in order to reduce noise of a light detection unit, thereby simplifying a construction of the bio-diagnosis apparatus and minimizing paths of light.

While the exemplary embodiments have been particularly shown and described above, it will be understood by those of ordinary skill in the art that various changes in form and details may be made therein without departing from the spirit and scope of the inventive concept as defined by the following claims.

1. A light transmissive temperature control apparatus comprising:
at least one tube which is formed of a light transmissive material and configured to contain a sample; and
a temperature control unit which accommodates at least a part of the at least one tube which is transparent, guides light to be irradiated onto the at least one tube, and controls a temperature of the at least one tube.

2. The light transmissive temperature control apparatus of claim 1, wherein the temperature control unit comprises a thermoelectric device block comprising at least one hole in which the at least a part of the at least one tube is inserted.

3. The light transmissive temperature control apparatus of claim 1, wherein the temperature control unit comprises an electrode formed of a transparent material and generating heat if current is applied to the electrode.

4. The light transmissive temperature control apparatus of claim 3, further comprising:
a heat sink formed of a thermal transfer material to transfer out heat generated from the at least one tube.

5. The light transmissive temperature control apparatus of claim 4, wherein the heat sink comprises a heat pipe which surrounds the at least one tube, and through which a cooling material flows.

6. The light transmissive temperature control apparatus of claim 1, wherein the temperature control unit comprises:
a thermoelectric device block comprising at least one hole in which at least a part of the at least one tube is inserted, and controls the temperature of the at least one tube; and
a heating block comprising:
a transparent layer formed of a transparent material and disposed on one surface of the thermoelectric device block to support a bottom end of the at least one tube; and
an electrode formed on the transparent layer and generating heat if current is applied to the electrode.

7. The light transmissive temperature control apparatus of claim 1, wherein the temperature control unit comprises:
a transparent layer formed of a transparent material and at least one accommodation groove into which the at least one tube is inserted; and
an electrode formed on the transparent layer and generating heat.

8. A bio-diagnosis apparatus comprising:
the light transmissive temperature control apparatus of claim 1;
a light generation unit disposed on one side of the light transmissive temperature control apparatus and irradiating the light onto the at least one tube; and
a light detection unit disposed on another side of the light transmissive temperature control apparatus and detecting emission light generated from the at least one tube.

9. The bio-diagnosis apparatus of claim 8, wherein the light generation unit comprises:
a light source which generates the light; and
at least one optical fiber which transmits the light output from the light source into the at least one tube, respectively.

10. The bio-diagnosis apparatus of claim 9, wherein the at least one optical fiber comprises a plurality of optical fiber bundles having a same length, and
wherein the light is transmitted into the at least one tube through the plurality of optical fibers, respectively.

11. The bio-diagnosis apparatus of claim 9, wherein the light generation unit further comprises a homogenizing lens which homogenizes the light output from the light source and transfers the light to each of the at least one optical fiber.

12. (canceled)

13. (canceled)

14. The bio-diagnosis apparatus of claim 8, wherein the temperature control unit comprises a thermoelectric device block which comprises at least one hole in which the at least a part of the at least one tube is inserted, and controls the temperature of the at least one tube; and
wherein the at least one hole is formed from one surface of the thermoelectric device block and connected to another at least one hole formed from another surface thereof, respectively, and is transparent between the at least one hole and the other at least one hole, respectively.

15. The bio-diagnosis apparatus of claim 14, wherein at least one optical fiber is inserted into the other at least one hole, respectively, from the other surface of the thermoelectric device block, and at least one lid which blocks the other at least one hole, respectively, is installed in the other surface of the thermoelectric device block.

16. A bio-diagnosis apparatus comprising:
the light transmissive temperature control apparatus of claim 1 comprising:
a thermoelectric device block which comprises at least one support hole, in which the at least a part of the at least one tube is inserted, respectively; and
at least one a light transmissive hole, connected to the at least one support hole, respectively, through which the light is transmitted to the at least one tube; and
a light generation unit which outputs the light from a light source; and
a light detection unit detecting emission light generated from the at least one tube by the light transmitted through the at least one light transmissive hole,
wherein the at least one support hole and the at least one light transmissive hole are connected to each other, respectively, at an angle equal to or less than 90°.

17. The bio-diagnosis apparatus of claim 16, wherein the at least one support hole and the at least one light transmissive hole are connected to each other, respectively, at an angle equal to or less than 90° so that a light path of the light output from the light source and a light path of the emission light forms the angle equal to or less than 90°.

18. (canceled)

19. (canceled)

20. The bio-diagnosis apparatus of claim 16, wherein the light generation unit comprises:
a first light source which outputs excitation light of a first wavelength band into a first light transmissive hole among the at least one light transmissive hole; and
a second light source which outputs excitation light of a second wavelength band into a second light transmissive hole among the at least one light transmissive hole.

21. The bio-diagnosis apparatus of claim 20, wherein the excitation lights output from the first and second light sources are transmitted into the first and second light transmissive holes to be incident on corresponding tubes among the at least one tube, respectively and simultaneously.

22. The bio-diagnosis apparatus of claim 16, wherein a straight medium which increases straightness of the light or optical fiber is filled in an entrance part of the at least one light transmisisve hole or at least a part thereof.

23. The bio-diagnosis apparatus of claim 16, wherein the thermoelectric device block is configured to rotate about a rotational axis,
wherein the at least one light transmissive hole comprises a plurality of light transmissive holes and is disposed in the thermoelectric device block to form a circle with respect to the rotational axis, and
wherein when the thermoelectric device block rotates in such a way that each of the plurality of light transmissive holes are sequentially disposed at a position corresponding to the light.

24. The bio-diagnosis apparatus of claim 23, wherein the light generation unit comprises a plurality of light sources generating respective excitation lights having different wavelengths, and
wherein a combination of the respective excitation lights is incident on the at least one tube through the at least one light transmissive hole.

25. The bio-diagnosis apparatus of claim 24, wherein the combination of the respective excitation lights is generated by using reflective filters which changes light paths of at least one of the respective excitation lights to a same light path.

26. The bio-diagnosis apparatus of claim 25, wherein at least one of the respective excitation lights is directly incident on the at least one tube through the same light path without changing an original light path.

27. The bio-diagnosis apparatus of claim 16, wherein the at least one support hole is formed to penetrate from a top surface of the thermoelectric device block to a bottom surface thereof, and to receive the light incident through the bottom surface, and
wherein the at least one light transmissive hole is configured to output emission light generated from the at least one tube.

28. The bio-diagnosis apparatus of claim 16, wherein at least one of the light generation unit and the light detection unit comprises an excitation filter which transmits the light of a selected wavelength band and the emission light of the selected wavelength band.

29. (canceled)

30. A method of diagnosing biochemical reaction using a bio-diagnosing apparatus comprising a thermoelectric device block, the method comprising:
inserting at least one transparent container containing a sample into at least one support hole formed in the thermoelectric device block;
controlling a temperature of the at least one container through the thermoelectric device block so that the sample undergoes the biochemical reaction;
irradiating excitation light on the at least one container through at least one light transmissive hole connected to the at least one support hole, respectively; and
detecting emission light generated from the at least one container through a light path which is different from a light path of the excitation light.

31. The method of claim 30, wherein the light path through with the emission light is generated and the light path of the excitation light form an angle equal to or less than 90°.

32. The method of claim 30, wherein the excitation light is irradiated on the at least one container during the biochemical reaction.

33. The method of claim 30, wherein the excitation light is a combination of lights generated from a plurality of light sources.

34. The method of claim 30, wherein the at least one support hole is disposed at a circumference of the thermoelectric device block, and
wherein the irradiating comprises rotating the thermoelectric device block around a rotational axis thereof, and irradiating the excitation light on each of the at least one container through a corresponding one of the at least one light transmissive hole during the rotating the thermoelectric device block.

35. The method of claim 34, wherein the light path through with the emission light is generated and the light path of the excitation light form an angle equal to or less than 90°.
